(19) United States
(12) Patent Application Publication
(10) Pub. No.: US 2024/0046383 A1
(43) Pub. Date: Feb. 8, 2024

(54) VACATION PACKAGING CONFIGURATOR

(71) Applicant: WWSG TRAVEL, INC. D/B/A VACAYOU, Treasure Island, FL (US)

(72) Inventor: Muirgheal Montecalvo, Treasure Island, FL (US)

(21) Appl. No.: 18/356,728

(22) Filed: Jul. 21, 2023

Related U.S. Application Data
(60) Provisional application No. 63/394,666, filed on Aug. 3, 2022.

(51) Int. Cl. G06Q 50/14; G06Q 10/02

(52) U.S. Cl. CPC G06Q 50/14; G06Q 10/02

(57) ABSTRACT

Described herein relates to a system of and method for optimizing structuring, booking, and/or viewing at least one travel itinerary, vacation package, and/or property package in real-time. The vacation package configurator system may automatically search and/or cache vacation topics, such as at least one wellness experiences and/or at least one property (e.g., a hotel). Additionally, the vacation package configurator may automatically combine the two aspects (e.g., a third-party jet ski tour and a king size bed room within a selected property) into bookable and/or dynamic packages. Accordingly, the vacation packages may be structured such that the vacation package configurator system may automatically verify the real-time pricing and/or availability of the selected vacation package and/or property package within the booking process. As such, in embodiments, a user may be enabled to make real-time bookings of the vacation package.

### CROSS-REFERENCE TO RELATED APPLICATIONS

This nonprovisional application claims the benefit of U.S. Provisional Application No. 63/394,666 entitled “VACATION PACKAGING CONFIGURATOR” filed Aug. 3, 2022 by the same inventor(s), all of which is incorporated herein by reference, in its entirety, for all purposes.

### BACKGROUND OF THE INVENTION

### 1. Field of the Invention

This invention relates, generally, to an integrated platform (e.g., system) for travel itinerary. More specifically, it relates to a system and method for optimizing structuring, booking, and/or viewing at least one travel itinerary (e.g., trip), at least one vacation package (e.g., vacation), and/or at least one property package in real-time.

### 2. Brief Description of the Prior Art

Usually, planning, booking, and viewing a travel itinerary can be quite a time-intensive process. A user typically must rely on multiple websites and/or platforms to plan or book various trip components, such as hotels, airfare, rental cars, golf outings, and spa retreats. Users will usually have to look through the individual company websites and enter their search, personal, and payment information repeatedly before they can officially book the trip. Accordingly, it can be increasingly difficult for a user to keep track of the entire travel itinerary, due to having to know log-in and personal information to view the entire trip.

Additionally, many times several key aspects of the user's trip may not be available during the certain range of dates that a user was interested in travelling. The user may book the hotel or airfare without first realizing that the golf course no longer has the times available for their trip. While users in the past used travel agencies to book each aspect of the travel itinerary, the travel agencies may be extremely costly and force the user to remove certain items or events from the trip in order to cover the travel agency costs.

Recent advances in travel itinerary software have enabled use of API, allowing the user to use an integrated single platform on a computing device to select aspects uniformly and succinctly for a vacation, while the travel itinerary software interacts with the third-party corporation websites and/or platforms. However, the currently known travel itinerary software using this technology—such as the one disclosed in U.S. Pub. No. 2021/0326780 (Published Oct. 21, 2021)—require that the user to select certain parameters, such as price range, for a predetermined date in order to book the trip. Accordingly, applications of such travel itinerary software are limited to certain items and events that are available at that time, and at that specified price range. Thus, currently known travel itinerary software is incapable of selecting every item and event the user desires, at the lowest available price, with a range of available dates for the desired package.

Accordingly, what is needed is an easy-to use, succinct, vacation packaging configurator which allows a user to include all desired aspects of the vacation package at the lo west available price. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need for an easy-to use, succinct, vacation packaging configurator which allows a user to include all desired aspects of the vacation package at the lowest available price is now met by a new, useful, and/or nonobvious invention.

An aspect of the present disclosure pertains to a method for optimizing vacation package structuring, booking, and/or viewing. In an embodiment, the method may comprise the following steps: (a) providing, via a vacation package configurator, a plurality of travel topics to a user; (b) generating, via incorporating at least one user selected travel topic of the plurality of travel topics within the vacation package configurator, a set of parameters associated with a vacation, such that at least one of the set of parameters may comprise a location and/or a duration of the vacation; (c) analyzing, via a compatibility algorithm of the vacation package configurator, the set of parameters to identify and/or create at least one recommended vacation package and/or property package, such that the at least one recommended vacation package and/or property package may have a highest value of dynamism with respect to the set of parameters; (d) receiving, via at least one user interface associated with the vacation package configurator, a selection corresponding to the least one recommended vacation package and/or property package; (e) validating, using at least one third-party application programming interface (hereinafter “API”) and/or at least one Availability, Rates, and Inventory programming interface (hereinafter “ARI”) a pricing, an availability, or both of the at least one selected vacation package and/or property package, in real-time; and (f) automatically booking, based on the real-time validation of the pricing, availability or both, the selected vacation package and/or property package.

In some embodiments, the step of validating the at least one vacation package and/or property package may further comprise the step of, comparing an original pricing and/or an original availability of the at least one selected vacation package and/or property package with the real-time pricing and/or real-time availability of the at least one selected vacation package and/or property package provided by the at least one API and/or at least one ARI. As such, in these other embodiments, the step of automatically booking the at least one selected vacation package and/or property package, may further comprise the steps of, based on a determination that the original pricing, and/or original availability of the at least one selected vacation package and/or property package does not match the real-time pricing and/or the real-time availability of the at least one selected vacation package and/or property package, transmitting a notification indicative of an inability to book the selected vacation package and/or property package; and based on a determination that the original pricing and/or original availability of the at least one selected vacation package and/or property package matches the real-time pricing and/or the real-time availability of the at least one selected vacation package and/or property package, transmitting a notification indicative of successfully booking the at least one selected vacation package and/or property package.

In addition, in some embodiments, the method may further comprise the step of, presenting to the user an acceptance module comprising a booking summary of the at least one selected vacation package and/or the property. In this manner, the booking summary may comprise a room selection and/or cancellation terms.

Further, in some embodiments, the step of presenting the at least one recommended vacation package and/or property package may comprise providing the at least one recommended vacation package and/or property package in list formatting. In these other embodiments, the at least one recommended vacation package and/or property package with the highest value of dynamism may appear at the top of the list.

In some embodiments, the vacation packaging configurator may further comprise a customizable module. In these other embodiments, the method may also further comprise the step of, updating, via the customizable module, at least one wellness experience and/or at least one property option of the at least one vacation package and/or property package. As such, the step of updating the at least one wellness experience, and/or the at least one property option of the at least one selected vacation package and/or property package may further comprise the step of, assigning, via the customizable module, the at least one wellness experience and/or the at least one property option to the user and/or at least one guest. Additionally, in these other embodiments, the step of updating the at least one wellness experience and/or the at least one property option of the at least one selected vacation package and/or property package may further comprise the step of, automatically updating, via the at least one API and/or at least one ARI, the real-time price of the at least one selected vacation package and/or property package.

Moreover, another aspect of the present disclosure pertains to a vacation packaging configurator system for structuring, booking, and/or viewing vacation packages. In an embodiment, the system may comprise the following: (a) a preference profile module configured to receive a set of parameters associated with a vacation, such that the parameters may comprise a location and/or a duration of the vacation; (b) a recommendation module configured to analyze the set of parameters to identify and/or at least one recommended vacation package and/or property package, such that the at least one recommended vacation package and/or property package may have a highest value of dynamism with respect to the set of parameters; (c) a real-time package availability and pricing module configured to validate, using at least one third-party application programming interface (hereinafter “API”) and/or at least one Availability, Rates, and Inventory programming interface (hereinafter “ARI”), a pricing and/or an availability of the at least one recommended vacation package and/or property package; (d) a booking module configured to automatically book the at least one recommended vacation package and/or property package; and (e) an acceptance module configured to present to the user an acceptance module of the at least one recommended vacation package and/or property package.

In some embodiments, the real-time package availability and pricing module may be further configured to compare an original pricing and/or an original availability of the at least one recommended vacation package and/or property package with the real-time pricing and/or real-time availability of the at least one recommended vacation package and/or property package provided by the at least one API and/or at least one ARI.

In some embodiments, the acceptance module of the vacation packaging configurator system may also be configured to present a booking summary to the user. In these other embodiments, the booking summary may comprise a room selection, cancellation terms, and/or refund terms.

In addition, in some embodiments, the vacation packaging configurator system may further comprise a customizable module configured to update at least one wellness experience and/or at least one property option of the at least one recommended vacation package and/or property package. As such, the customizable module may be further configured to assign the at least one wellness experience and/or the at least one property option to the user and/or at least one guest. In these other embodiments, the customizable module may also be configured to automatically update, via the at least one API and/or at least one ARI the real-time price of the at least one recommended vacation package and/or property package.

In some embodiments, the vacation packaging configurator system may also comprise an interface module configured to communicatively couple at least one selected from the group consisting of a third-party program, software, and/or computing device with the vacation packaging configurator system.

Furthermore, an additional aspect of the present disclosure pertains to a method for optimizing vacation package structuring, booking, and viewing. In an embodiment, the method may comprise the following steps: (a) generating a set of parameters from a user, such that at least one of the set of parameters may comprise a location and/or a duration of a vacation; (b) analyzing the set of parameters to identify and/or create at least one vacation package and/or property package, wherein the at least one vacation package and/or property package has a highest value of dynamism with respect to the set of parameters; (c) validating, using at least one third-party application programming interface (hereinafter “API”) and/or at least one Availability, Rates, and Inventory programming interface (hereinafter “ARI”), a pricing and/or an availability of the at least one vacation package and/or property package, in real-time; and (d) automatically booking, the at least one vacation package and/or property package by: (i) based on a determination that an original pricing and/or an original availability of the at least one vacation package and/or property package does not match the real-time pricing and/or the real-time availability of the at least one vacation package and/or property package, transmitting a notification indicative of an inability to book the at least one vacation package and/or property package; and (ii) based on a determination that an original pricing and/or an original availability of the at least one vacation package and/or property package matches the real-time pricing and/or the real-time availability of the at least one vacation package and/or property package, transmitting a notification indicative of successfully booking the at least one vacation package and/or property package.

In some embodiments, the vacation packaging configurator system automatically searches and caches vacation topics, such as wellness experiences and hotel stays, automatically combines the two entities into bookable, and dynamic packages. Accordingly, in some embodiments, the vacation packages may be structured such that the system and method automatically optimizes the booking process, such that the user is enabled to make real-time bookings of the vacation package.

Moreover, when booking the vacation package for the user, the vacation packaging configurator system may compare the real-time availability and price of the vacation package with the originally cached availability and price, via Availability, Rates, and Inventory (hereinafter “ARI”) and/or Application Programming Interface (hereinafter “API”) programming. Furthermore, if the real-time availability and price of the vacation package is not substantially similar to the originally cached availability and price of the vacation package, the vacation packaging configurator system may send a notification to the user of the price and availability change. Additionally, in some embodiments, the vacation packaging configurator system may automatically input the personal and payment information of the user to optimize the booking process of the vacation package for the user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a vacation packaging configurator system integrated with internal and external data sources, creating both standard vacation packages and user-specific vacation packages, according to an embodiment of the present disclosure.

FIG. 2 is a vacation packaging configurator system integrated with internal and external data sources, creating both standard vacation packages and user-specific vacation packages with real-time ARI verification, according to an embodiment of the present disclosure.

FIG. 3 is a flow diagram of modules for a vacation packaging configurator system, according to an embodiment of the present disclosure.

FIG. 4A depicts an exemplary configuration of a hotel preference profile of a vacation packaging configurator system, according to an embodiment of the present disclosure.

FIG. 4B depicts an exemplary configuration of a selection of a hotel preference profile of a vacation packaging configurator system by a user, according to an embodiment of the present disclosure.

FIG. 4C depicts an exemplary configuration of a hotel output of a vacation packaging configurator system based on a selection inputted by a user, according to an embodiment of the present disclosure.

FIG. 4D depicts an exemplary configuration of a selected property package of a vacation packaging configurator system, according to an embodiment of the present disclosure.

FIG. 4E depicts an exemplary configuration of a room selection of a selected vacation package of a vacation packaging configurator system, according to an embodiment of the present disclosure.

FIG. 4F depicts an exemplary configuration of a traveler information capture of a selected property package of a vacation packaging configurator system, according to an embodiment of the present disclosure.

FIG. 4G depicts an exemplary configuration of a payment capture of a selected property package of a vacation packaging configurator system, according to an embodiment of the present disclosure.

FIG. 4H depicts an exemplary configuration of a booking module of a selected property package on a vacation packaging configurator system, according to an embodiment of the present disclosure.

FIG. 5A depicts an exemplary configuration of a vacation package preference profile of a vacation packaging configurator system, according to an embodiment of the present disclosure.

FIG. 5B depicts an exemplary configuration of a selection of a vacation package preference profile of a vacation packaging configurator system by a user, according to an embodiment of the present disclosure.

FIG. 5C depicts an exemplary configuration of a vacation package output of a vacation packaging configurator system based on a selection inputted by a user, according to an embodiment of the present disclosure.

FIG. 5D depicts an exemplary configuration of a selected vacation package of a vacation packaging configurator system, according to an embodiment of the present disclosure.

FIG. 5E depicts an exemplary configuration of a room selection of a selected vacation package of a vacation packaging configurator system, according to an embodiment of the present disclosure.

FIG. 5F depicts an exemplary configuration of a traveler information capture of a selected vacation package of a vacation packaging configurator system, according to an embodiment of the present disclosure.

FIG. 5G depicts an exemplary configuration of a payment capture of a selected vacation package of a vacation packaging configurator system, according to an embodiment of the present disclosure.

FIG. 5H depicts an exemplary configuration of a booking module of a selected vacation package on a vacation packaging configurator system, according to an embodiment of the present disclosure.

FIG. 6A depicts an exemplary configuration of a guest button of a customizable module of a vacation packaging configurator system fora selected vacation package and/or a selected property package, according to an embodiment of the present disclosure.

FIG. 6B depicts an exemplary configuration of a guest button of a customizable module of a vacation packaging configurator system for a selected vacation package and/or a selected property package allowing a user and/or at least one guest to select and/or assign at least one room and/or at least one alternative room to the user and/or the at least one guest, according to an embodiment of the present disclosure.

FIG. 6C depicts an exemplary configuration of a service button of a customizable module of a vacation packaging configurator system for a selected vacation package and/or a selected property package, according to an embodiment of the present disclosure.

FIG. 6D depicts an exemplary configuration of a service button of a customizable module of a vacation packaging configurator system for a selected vacation package and/or a selected property package, allowing a user and/or at least one guest to select and/or assign at least one additional add-on service and/or at least one alternative service, according to an embodiment of the present disclosure.

FIG. 6E depicts an exemplary configuration of an activities button of a customizable module of a vacation packaging configurator system for a selected vacation package and/or a selected property package, according to an embodiment of the present disclosure.

FIG. 6F depicts an exemplary configuration of a customizable module confirmation of a vacation packaging configurator system for a selected vacation package and/or a selected property package, according to an embodiment of the present disclosure.

FIG. 7 is an exemplary process flow diagram depicting a method for digitally booking a vacation package on a computing device and/or providing real-time availability and/or prices in order to aid a user's vacation booking performance, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The computing device readable medium described in the claims below may be a computing device readable signal medium or a computing device readable storage medium. A computing device readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computing device readable storage medium would include the following: an electrical connection having one or more wires, a portable computing device diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computing device readable storage medium may be any tangible medium that can contain or store a program for use by or in connection with an instruction execution system, apparatus, or device.

A computing device readable signal medium may include a propagated data signal with computing device readable program PIN embodied therein, for example, in baseband or as part of a carrier wave. Such a propagated signal may take any of a variety of forms, including, but not limited to, electro-magnetic, optical, or any suitable combination thereof. A computing device readable signal medium may be any computing device readable medium that is not a computing device readable storage medium and that can communicate, propagate, or transport a program for use by or in connection with an instruction execution system, apparatus, or device.

Program PIN embodied on a computing device readable medium may be transmitted using any appropriate medium, including but not limited to wireless, wire-line, optical fiber cable, radio frequency, etc., or any suitable combination of the foregoing. Computing device program PIN for carrying out operations for aspects of the present invention may be written in any combination of one or more programming languages, including an object oriented programming language such as Java, C#, C++ or the like and conventional procedural programming languages, such as the “C” programming language or similar programming languages.

Aspects of the present invention are described below with reference to flowchart illustrations and/or block diagrams of methods, apparatus (systems) and computing device program products according to embodiments of the invention. It will be understood that each block of the flowchart illustrations and/or block diagrams, and combinations of blocks in the flowchart illustrations and/or block diagrams, can be implemented by computing device program instructions. These computing device program instructions may be provided to a processor of a general purpose computing device, special purpose computing device, or other programmable data processing apparatus to produce a machine, such that the instructions, which execute via the processor of the computing device or other programmable data processing apparatus, create means for implementing the functions/acts specified in the flowchart and/or block diagram block or blocks.

These computing device program instructions may also be stored in a computing device readable medium that can direct a computing device, other programmable data processing apparatus, or other devices to function in a particular manner, such that the instructions stored in the computing device readable medium produce an article of manufacture including instructions which implement the function/act specified in the flowchart and/or block diagram block or blocks.

The computing device program instructions may also be loaded onto a computing device, other programmable data processing apparatus, or other devices to cause a series of operational steps to be performed on the computing device, other programmable apparatus or other devices to produce a computing device implemented process such that the instructions which execute on the computer or other programmable apparatus provide processes for implementing the functions/acts specified in the flowchart and/or block diagram block or blocks.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

As used herein, the term “Availability, Rates, and Inventory (hereinafter “ARI”)” refers to any programming which controls pricing, availability, and inventory, and provides constraints on how these can be combined. For ease of reference, the exemplary embodiment, described herein, employs the ARI for vacation topics, but this description should not be interpreted as exclusionary of other types of ARI programming.

As used herein, the term “vacation topics” refers to any aspect which may be incorporated into a vacation. Non-limiting examples of vacation topics may include cruises, airfare, hotels, rental cars, spas, golf courses, or any aspect of a vacation known in the art. For ease of reference, the exemplary embodiment, described herein, refers to hotels, spas, golf, airfare, and a rental car, but this description should not be interpreted as exclusionary of other types of vacation topics.

As used herein, the term “Application Programming Interface” (hereinafter “API”) refers to any programming or software intermediary that allows an application to communicate with a third-party application. For ease of reference, the exemplary embodiment, described herein, refers to a programming which communicates with hotel, airfare, golf, spa, and rental car applications, but this description should not be interpreted as exclusionary of other types of third-party applications.

As used herein, the term “computing device” refers to any functional electrical component known in the art which can perform substantial computations, including numerous arithmetic operations and/or logic operations without human intervention. Non-limiting examples of the computing device may include a laptop, a mobile device, a computer, and/or a tablet. For ease of reference, the exemplary embodiment described herein refers to a mobile device and/or a computer, but this description should not be interpreted as exclusionary of other functional electrical components.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

The terms “about,” “approximately,” or “roughly” as used herein refer to being within an acceptable error range for the particular value as determined by one of ordinary skill in the art, which will depend in part on how the value is measured or determined, i.e., the limitations of the measurement system, i.e., the degree of precision required for a particular purpose, such real-time pricing of an activity and/or hotel. As used herein, “about,” “approximately,” or “roughly” refer to within +15% of the numerical.

All numerical designations, such as pH, temperature, pricing, time, concentration, and/or molecular weight, including ranges, are approximations which are varied up or down by increments of 1.0, 0.1, 0.01 or 0.001 as appropriate. It is to be understood, even if it is not always explicitly stated, that all numerical designations are preceded by the terms “about,” “approximately,” or “roughly.” It is also to be understood, even if it is not always explicitly stated, that the compounds, components, modules, and/or structures described herein are merely exemplary and that equivalents of such are known in the art and/or can be substituted for the compounds, components, modules, and/or structures explicitly stated herein.

Wherever the term “at least,” “greater than,” or “greater than or equal to” precedes the first numerical value in a series of one or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of one or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Vacation Packaging Configurator

The present invention pertains to an integrated vacation packaging configurator system (e.g., a platform, a program, and/or software) (hereinafter “vacation packaging configurator”, “vacation packaging configurator system”, “vacation packaging configurator platform” and/or “vacation packaging configurator software”) and method for optimizing structuring, booking, and/or viewing at least one travel itinerary (e.g., trip), vacation package (e.g., vacation), and/or property package in real-time. In an embodiment, the vacation packaging configurator may be configured to communicatively couple and/or interface with any third-party travel, hotel, and/or vacation software, program, platform, and/or computing device known in the art, via any Availability, Rates, and Inventor (hereinafter “ARI”) interface software and/or programming, and/or booking Application Programming Interface (hereinafter “API”) software and/or programming known in the art. In this manner, the integrated vacation packaging configurator may include an integrated platform—such as a website, a mobile application, and/or any software applicable to any computing device known in the art, such that the vacation platform may be configured to interact with a user through at least one user interface (e.g., a graphical user interface) communicatively couple to the computing device of the vacation packaging configurator, and/or may be configured to provide the user, with a significantly eased vacation experience through the vacation package, removing any need to personally plan, explore, and/or book individual components of the desired vacation of the user. In this manner, the computing device of the vacation packaging configurator may comprise at least one processor. As such, the vacation packaging configurator may also be configured to interface and/or be uploaded within at least one alternative computing device and/or at least one third-party computing device.

In an embodiment, the vacation packaging configurator may selectively verify and/or cache at least one vacation topic of a plurality of travel topics. In this manner, the vacation packaging configurator, via API, may be configured to perform an inquiry for a specified vacation topic of a plurality of travel topics, such that the vacation packaging configurator may be configured to interface with at least one third-party software, program, and/or computing device comprising all associated data and/or import all associated data into a local dataset within the computing device. Subsequently, in this embodiment, the vacation packaging configurator may cache the ARI of the vacation topic, via interfacing with any third-party software, program, and/or computing device comprising the associated data and/or save all imported associated data within the local data set. As such, the vacation packaging configurator may associate certain preference profiles with the at least one of a plurality of travel topics, allowing a user, via the computing device, to find the at least one vacation topic via selecting the certain preference profiles.

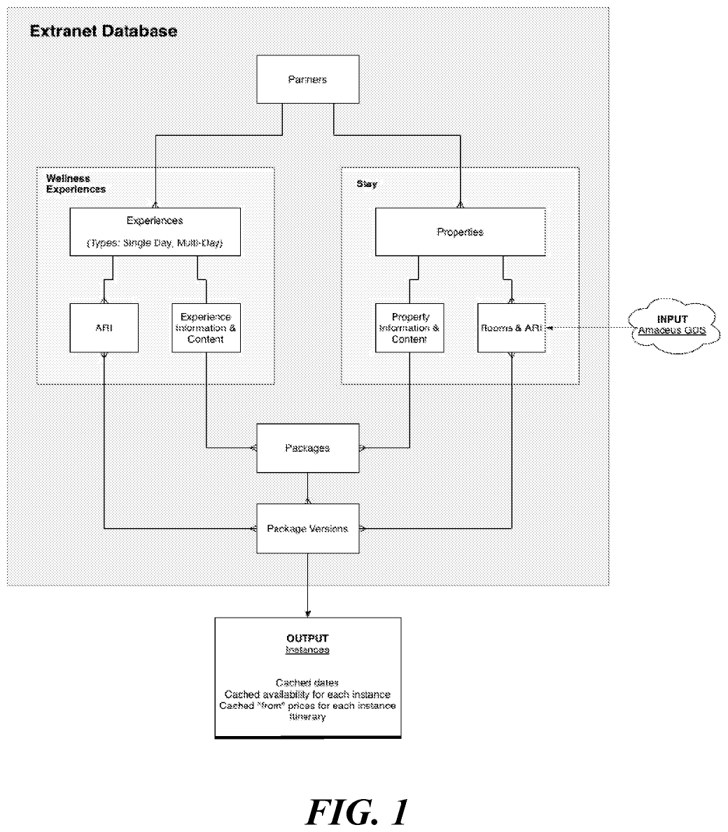

FIG. 1 depicts the vacation packaging configurator integrated with internal and/or external data sources, creating both standard vacation packages and/or user-specific vacation packages, according to an embodiment of the present disclosure. In some embodiments, the vacation packaging configurator may be configured to integrate and/or communicate with only an internal data source. In this manner, in some embodiments, the integrated vacation packaging configurator system may integrate at least one of a plurality of external data source.

In an embodiment, as shown in FIG. 1, the vacation packaging configurator may import data through the API, incorporating ARI data and/or any additional data associated with at least one of the plurality of travel topics within the software, program, platform, and/or computing device. As such, in this embodiment, the ARI data and/or additional data may be collected and/or cached from at least one third party database (e.g., a travel agency database (e.g., Amadeus GDS)), such that the vacation packaging configurator, via API, may search and/or cache associated data related to at least one of the plurality of travel topics on a local database. Additionally, in some embodiments, the user may provide the data to the vacation packaging configurator through at least one data storage device (e.g., a USB interface), via the computing device.

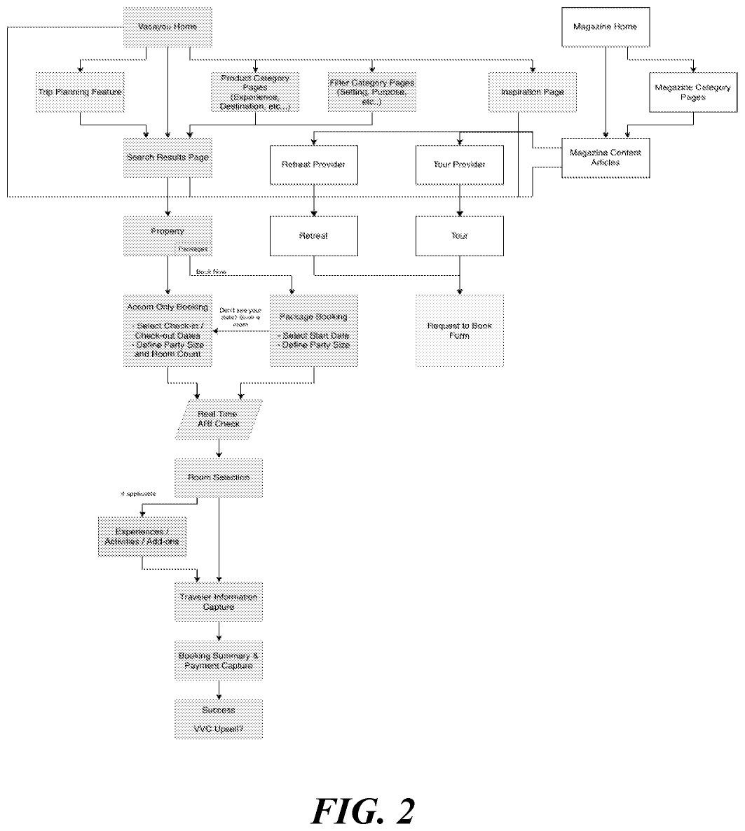

Moreover, in an embodiment, when vacation topics are sorted and combined into a vacation package, the integrated vacation packaging configurator may filter at least one of the plurality of travel topics through at least one compatibility algorithm outputting a specific value describing the dynamism of at least one vacation topic and/or at least one vacation topic grouping of the plurality of travel topics. In this manner, as shown in FIGS. 1-2, in this embodiment, the plurality of travel topics may be filtered into at least two major categories, such as a wellness experience and/or a property. Accordingly, a plurality of wellness experiences may be grouped with a plurality of properties based on a plurality of preference profiles, including but not limited to, location, availability, price, and/or user reviews. In some embodiments, the vacation topics may be individually selected, such that the user may sort and/or filter at least one vacation topic of the plurality of travel topics. As such, in these other embodiments, the user may build a personalized vacation package. Additionally, the vacation packaging configurator may add or remove at least one wellness experience and/or property from the package to increase and/or decrease the purported dynamism value. Moreover, in some embodiments, the vacation packaging configurator may be configured to identify and/or associate the user and/or at least one guest with the at least one selected wellness experience and/or property, via the at least one user interface. Furthermore, in an embodiment, as shown in FIG. 1, compatibility of vacation topics may be calculated by an internal data source (e.g., an equation and/or algorithm) and/or a third-party software, such that the vacation packaging configurator may interact with the third-party software through the API.

Another feature of the present disclosure is that the vacation packaging configurator may merge and/or combine an individual pricing of the at least one wellness category and/or the at least one property, such that the vacation packaging configurator may provide the user with an estimated total cost of the personalized vacation package. In this embodiment, as shown in FIG. 2, the vacation packaging configurator may utilize the ARI to query a real-time cost in order to verify accuracy of the estimated total cost. As such, the estimated total cost and/or available date range for the personalized vacation package may be readily displayed on the at least one user interface (e.g., graphical user interface) of the computing device, such that the user may be automatically notified of the cost and/or any potential price and/or availability changes, in real-time, via any auditory, visual, and/or tactile notification known in the art. In some embodiments, the integrated vacation packaging configurator may search and/or cache vacation topic data. Accordingly, in these other embodiments, the integrated vacation packaging configurator interface may also be configured to automatically display equivalent room rates of the vacation package on the at least one user interface.

Moreover, as shown in FIG. 2, in an embodiment, after the real-time cost has been verified, the user may be provided with additional modules, including but not limited to, room selection, add-ons (e.g., experiences, activities, and/or amenities, airfare, airline information, rental vehicle information), traveler information capture, payment capture, booking module, and/or any information profile known in the art, which a user may interact with in selecting a hotel and/or vacation. In this manner, as shown in FIG. 2, in this embodiment, the booking module may be configured to initiate the ARI to query the real-time cost to determine if the cost of at least one aspect of the hotel and/or vacation package has decreased from the initial estimate as provided by the vacation packaging configurator. As such, in some embodiments, the vacation packaging configurator, may provide a refund within a predetermined amount of time to the user based on the difference between the price captured by the vacation packaging configurator and the real-time cost, as provided by the ARI. Additionally, in some embodiments, after the ARI is utilized to query the real-time cost, the vacation packaging configurator may refund the user the difference between the price captured on the vacation packaging configurator and the actual cost of the hotel, vacation package, and/or a plurality of aspects provided by the vacation packaging configurator.

Furthermore, as shown in FIG. 2, the vacation packaging configurator may provide the user with an inspiration module, such that the inspiration module may include but is not limited to photographs, videos, 3D-tours, reviews, and/or an interactive communication system, such that the user may communicate with at least one user who had previously booked the at least one wellness experience (e.g., golf outing), the at least one property, the vacation package, and/or a similar wellness experience and/or property. In addition, as shown in FIG. 2, in this embodiment, the vacation packaging configurator may be configured to communicate with at least one third-party software, program, and/or computing device, such that the vacation packaging configurator may be configured to provide the user with additional hotel and/or vacation package information (e.g., property information and/or wellness experience information) from magazines, video blogs, web blogs, newspapers, periodical, social media, and/or any publication known in the art.

Additionally, as shown in FIG. 2, in an embodiment, the vacation packaging configurator may be communicatively coupled to a graphical administrator interface, such such that an administrator of the vacation packaging configurator may make changes to at least one of the plurality vacation packages, the plurality of wellness experience, and/or the plurality of properties, in addition to managing at least one booking of the user, in real-time. For example, if the at least one property (e.g., hotel), at least one wellness experience, and/or the vacation package is shown on the vacation packaging configurator, but is currently unavailable for booking, the vacation packaging configurator may be configured to provide a user with a booking form, such that the user may input their personal information and/or payment information, via the at least one graphical user interface communicatively coupled to the vacation packaging configurator, allowing the administrator for the vacation packaging configurator to contact the at least one property, at least one wellness experience, and/or vacation package provider and/or request booking for the user. As such, the administrator may manage the real-time bookings in several ways including, but not limited to, working as an intermediary to the user by booking the selected vacation package in real-time for the user, integrating specific property and/or wellness experience coupons or deals, and/or defining a contract duration of the vacation packages, allowing the user to interact with the terms via the at least one user interface.

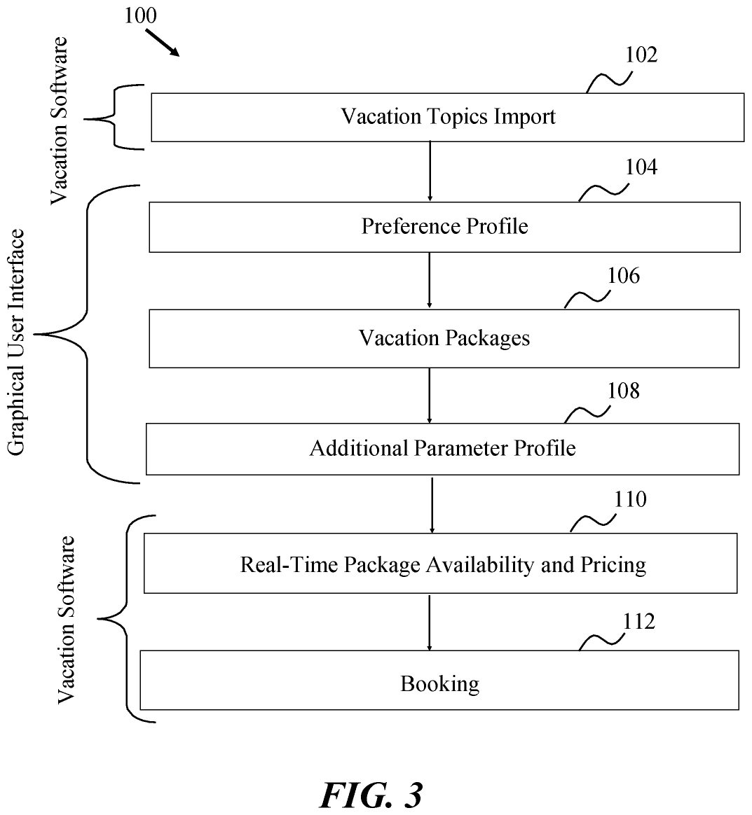

FIG. 3 depicts a flow diagram of modules for the vacation packaging configurator, according to an embodiment of the present disclosure. In an embodiment, the vacation packaging configurator 100 may include several aspects within the system. In this embodiment, the vacation packaging configurator 100 may comprise a plurality of travel topics import aspect 102, a preference profile aspect 104, a vacation package aspect 106, an additional parameter profile aspect 108, a real-time package availability and/or pricing aspect 110, and/or a booking aspect 112. In this embodiment, the plurality of travel topics import 102, the real-time package availability and/or pricing aspect, and/or the booking aspect 112 may be primarily software based only. The preference profile aspect 104, the vacation packages aspect 106, and/or additional parameter profile aspect 108 may be configured to allow the user to interact with the vacation packaging configurator 100, via the at least one user interface communicatively coupled to the vacation packaging configurator. Each of these aspects will be further detailed in the sections below.

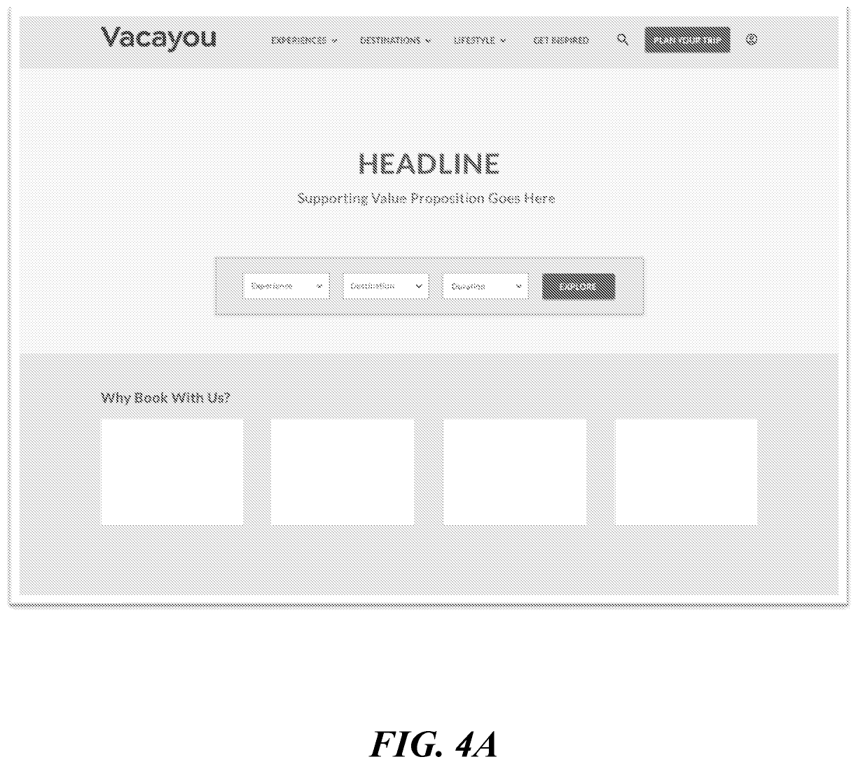

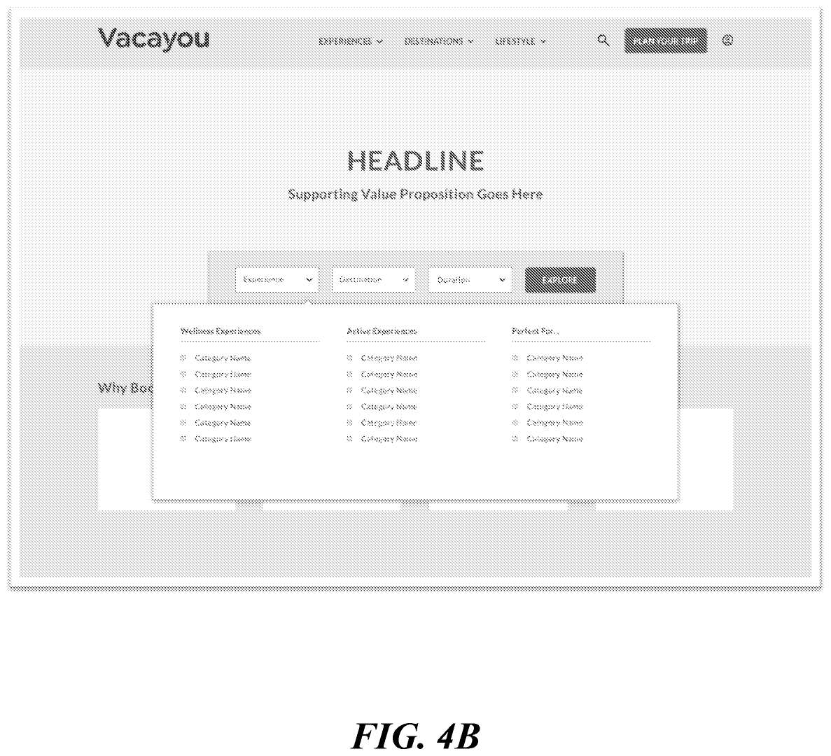

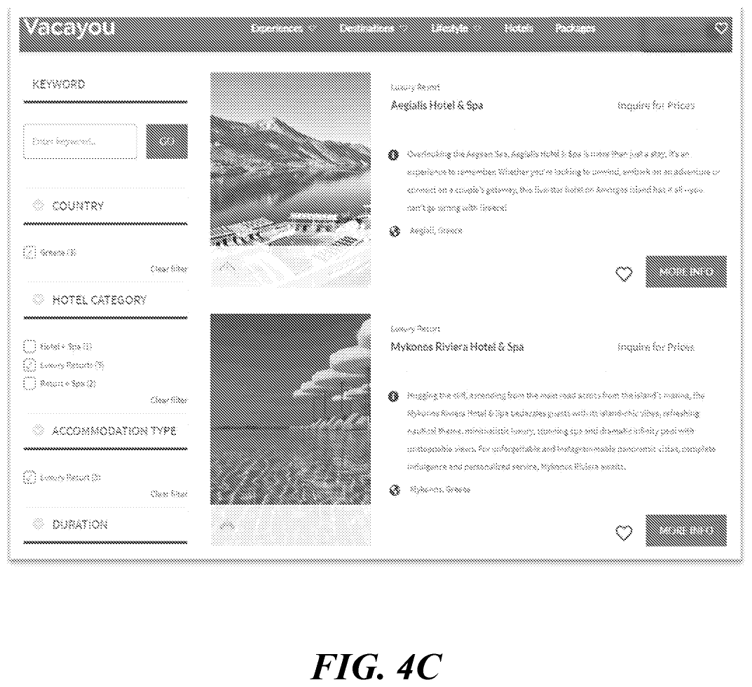

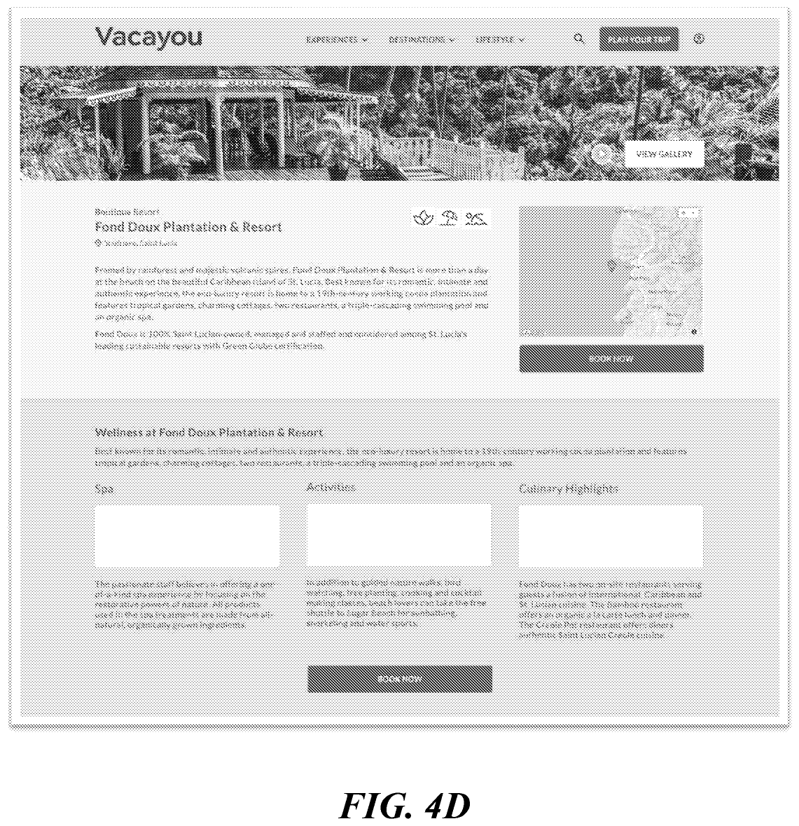

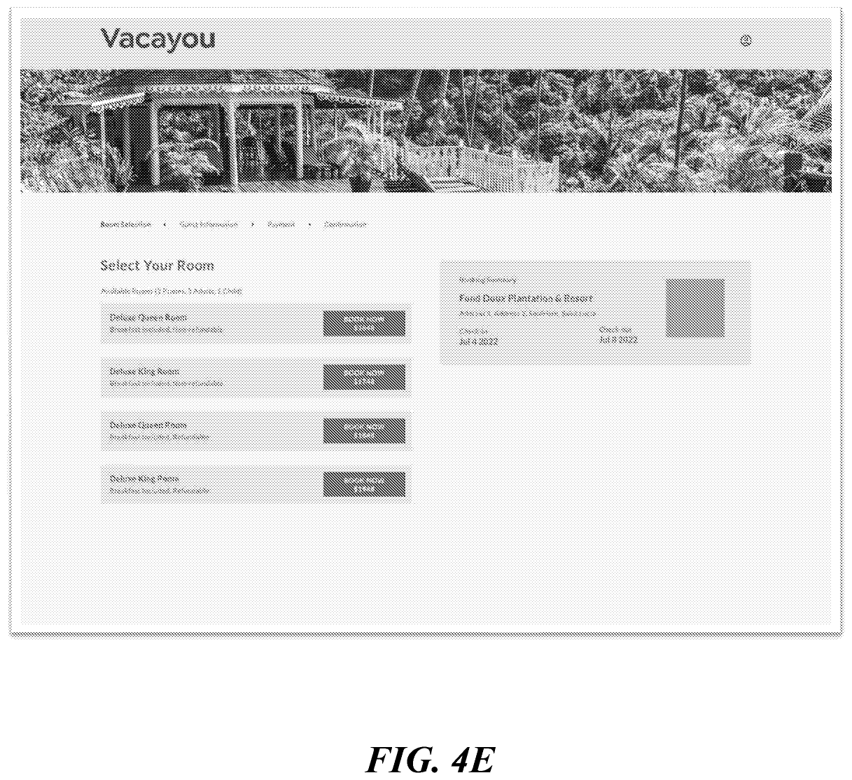

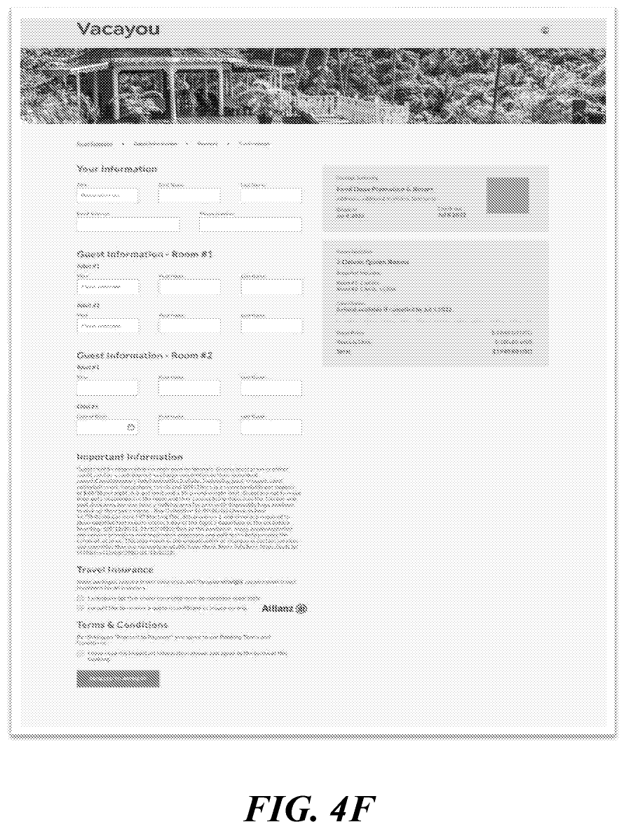

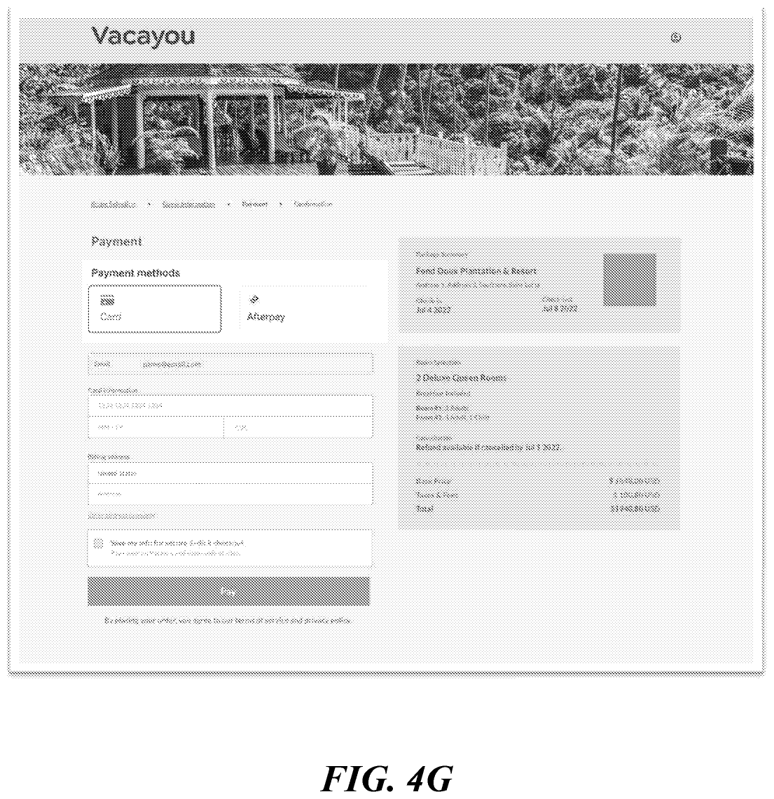

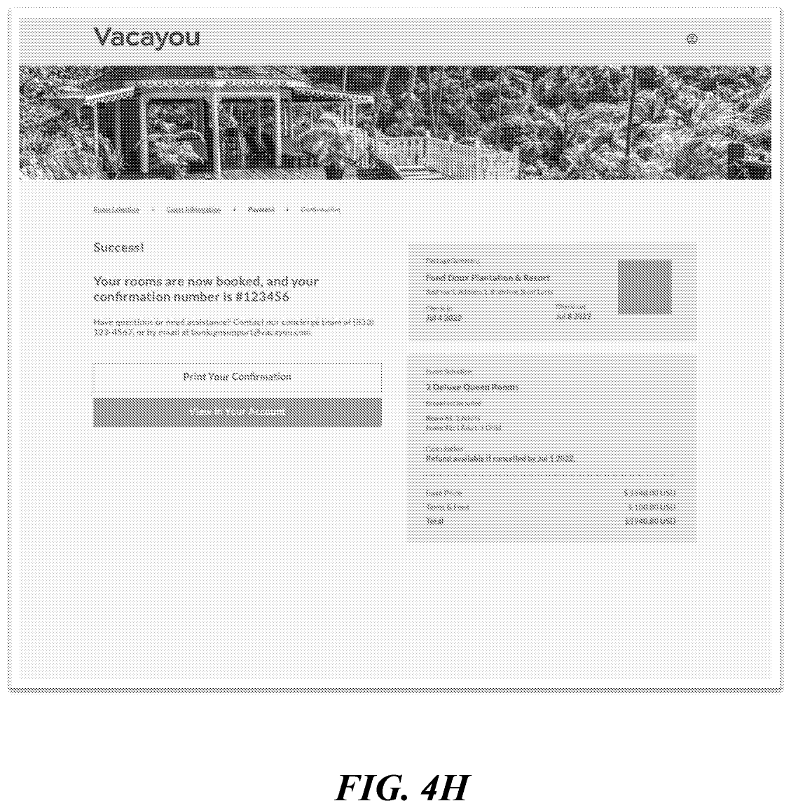

Additionally, the present disclosure may further include the selection and/or booking of predetermined property packages as shown in FIGS. 4A-4H. Accordingly, FIG. 4A depicts preference profile aspect 104, as shown in FIG. 3 for hotel selection on the vacation packaging configurator, according to an embodiment of the present disclosure. The preference profile aspect may include a plurality of options, suggestions, and/or questions which the user may select, allowing the integrated vacation package configurator software to filter potential property (e.g., hotel) matches. In an embodiment, the plurality of options includes, but is not limited to, country, state and/or province, property category, accommodation type, and/or duration. Additionally, the plurality of options, suggestions, and/or questions of preference profile aspect 104 may increase or decrease based on the initial selection and/or continued selection by the user. For example, in some embodiments, when the user selects a country outside of the United States, the user no longer has the option to select one of the fifty (50) states within the United States.

In an embodiment, the vacation packaging configurator may automatically remove at least one of the plurality of options based on user selection, property availability, and/or wellness experience availability to allow the user to select valid and/or relevant selections, increasing the efficiency of the user on the vacation packaging configurator. Moreover, as shown in FIG. 4B, in this embodiment, when the user selects a module within one of the plurality of options, the vacation packaging configurator removes at least one alternative module within the same option. In this manner, when the user deselects the highlighted module, at least one alternative module may be replaced. Moreover, the various modules within the plurality of options may be pre-selected by the vacation packaging configurator for convenience and/or the pre-selected modules may be altered by the user via the at least one user interface communicatively coupled to the computing device in association with the vacation packaging configurator. Furthermore, in this embodiment, as shown in FIG. 4B, in conjunction with FIG. 3, at least one of the plurality of options may be removed entirely and/or grouped together to increase efficiency of the use on the vacation packaging configurator. For example, when the module “Greece” was selected, the State and/or Province option was removed from preference profile aspect 104.

FIGS. 4C-4D, in conjunction with FIG. 3, depict the at least one property output of the vacation packaging configurator based on the selections of the user within preference profile aspect 104, according to an embodiment of the present disclosure. In an embodiment, the at least one property (e.g., hotel) output may be presented in a top-down format. Accordingly, the vacation packaging configurator may present the at least one property output with the at least one property having the closest the matches to the at least one module selected by the user within the plurality of options as the first property output presented at the top of the screen. Additionally, the vacation packaging configurator may configure the at least one property output, as shown in FIG. 4C, in a condensed form with only pertinent aspects (e.g., aspects the vacation packaging configurator may determine important to the user based on the at least one module selected by the user within the plurality of options within preference profile aspect 104) of the property provided, allowing the user to compare the at least one property output with at least one alternative property output. In this embodiment, the user may interact with each property output provided by the vacation packaging configurator, such that when the user interacts with the at least one property output, via the user interface, the vacation packaging configurator may expand the condensed form of the at least one output, such that additional details for at least one property option may be provided on a display device in association with the computing device of the vacation packaging configurator, as shown in FIG. 4D. In some embodiments, the at least one property output may be presented in a left-to-right format. Additionally, in some embodiments, the vacation packaging configurator may provide additional recommendations for at least one alternative property option and/or style based on the preference profile of the user. For example, in these other embodiments, based on the preference profile of the user preferring villas, the vacation packaging configurator may provide at least one alternative recommendation comprising a villa property comprising the closet matches to modules selected by the user within the plurality of options of preference profile aspect 104. Furthermore, in an embodiment, the vacation packaging configurator may be configured to input at least one of the plurality of property options within a ranking algorithm and/or equation, such that a recommendation rating may be provided for each property option, with the property output most similar to the profile preference of the user receiving the highest rating and/or the property output least similar to the profile preference of the user receiving the lowest rating.

FIG. 4E depicts a room selection of the at least one selected property of the vacation package of the vacation packaging configurator, according to an embodiment of the present disclosure. In an embodiment, after the user selects the at least one property from at least one property outputs provided by the vacation packaging configurator, the vacation packaging configurator may be configured to display a module comprising the room selection, such that the user may interact with the room selection module, via the at least one user interface of the computing device in association with the vacation packaging configurator. Accordingly, the room selection module, as shown in FIG. 4E, in conjunction with FIG. 3, may provide the user with at least one room option based on preference profile aspect 104, as provided by the user. For example, for a user who inputs a preference within preference profile aspect 104 comprising 2 rooms, 3 adults, and one child, the room selection may provide several options which may match and/or as closely conform to the preference profile (e.g., a deluxe queen room, a deluxe king room, standard queen room, a standard king room), as possible. Furthermore, in an embodiment, the room selection module may display at least one experience, activity, and/or add-ons (e.g., rental vehicle, airfare, airline, kayaking, hiking, all-inclusive meals, complimentary Wi-Fi). Accordingly, in this embodiment, the user may interact with the room selection module, via at least one user interface of the computing device, such that the user may select the room based on the size, experiences, activities, add-ons provided for the particular room based on the property package, and/or any other room category known in the art. Additionally, as shown in FIGS. 4E-4G, the vacation packaging configurator may display a property package summary, including but not limited to the selected property package location, the check-in and/or check-out time of the selected property package, the additional inclusions of the selected property package, the estimated cost of the selected property package, as provided by the vacation packaging configurator, refund information, and/or any information known in the art which would be included in booking a hotel.

In an embodiment, once the user has selected the predetermined vacation package and/or property package, the integrated vacation package configurator software may configure the display device and/or the at least one user interface (e.g., graphical user interface) in association with the computing device for the vacation packaging configurator to display traveler information capture, a payment capture and/or a booking module, as shown in FIGS. 4F-4H. Additionally, in this embodiment, the vacation packaging configurator may be configured to automatically book cancellation policies associated with the individual aspects of the predetermined property package and/or the predetermined vacation package without explicit user interaction. As shown in FIG. 4F, in an embodiment, the traveler capture may comprise a module where the user may input their personal information and/or the personal information of at least one guest, via the at least one user interface of the computing device. As such, in this embodiment, the user, via the at least one user interface, may select, assign, and/or identify at least one aspect of the predetermined property package and/or the predetermined vacation package to the user and/or the at least one guest. In this manner, the at least one guest may be able to participate in at least one aspect of the predetermined property package and/or the predetermined vacation package, whereas the user may be able to participate in at least one alternative aspect of the predetermined property package and/or the predetermined vacation package. Moreover, the user may be able to alter assignment of the at least one aspect to the user and/or the at least one guest after receiving confirmation of a booking of the predetermined vacation package and/or the predetermined property backage, via a edit a booking module within a profile module created for the user within the vacation packaging configurator, via the at least one user interface of the computing device in association with the vacation packaging configurator.

In addition, in an embodiment, the traveler capture module may include a section where the user can provide a desired check-in date and a desired check-out date. Additionally, as shown in FIG. 4G, in an embodiment, information for at least one payment method (e.g., credit cards, debit cards, Apple Pay, Venmo, Cryptocurrency) may be inputted by the user and cached by the vacation packaging configurator to complete all transactions, thereby reducing complexity of the booking process for the user, via the graphical user interface of the computing device. As such, the payment capture may display as a module and/or be configured to allow the user to input additional payment information from at least one additional third-party software in order to allow the user to pay through a predetermined payment software (e.g., monthly payments), via the at least one user interface of the computing device. For example, the user may input their profile data from a third-party payment software (e.g., Afterpay), such that the vacation packaging configurator may communicate with the third-party payment software, allowing the third-party payment software to provide the payment of the user at a predetermined time.

Furthermore, as shown in FIG. 4H, once the payment capture has been completed, the vacation packaging configurator may be configured to display a booking module, via the at least one user interface of the computing device in association with the vacation packaging configurator. In this embodiment, the booking module may display a notification indicative of a successful and/or a non-successful booking. In this manner, the vacation packaging configurator may be configured to utilize API and/or ARI to confirm that all aspects of the selected property package are available and have been booked by the vacation packaging configurator. Accordingly, if at least one aspect of the property package platform is no longer available, the vacation packaging configurator may be configured to display a notification in the booking module indicative of a non-successful booking, via at least one user interface of the computing device.

Furthermore, in some embodiments, once the user has successfully been inputted, the vacation packaging configurator may be configured to utilize the ARI to query the real-time cost of at least one aspect of the selected property package. As such, if at least one aspect of the selected property package has decreased, the booking module may be configured to automatically display a notification indicative of the vacation packaging configurator comprising a higher cost than necessary. Accordingly, in these other embodiments, the vacation packaging configurator may be configured to refund, via the inputted payment information provided by the user and/or at least one other payment method provided by the user, the difference in the real-time cost determined by the ARI and/or the estimated cost provided by the integrated vacation packaging configurator in a predetermined amount of time. Moreover, in some embodiments, the vacation packaging configurator may be configured to automatically refund the user, via the inputted payment information provided by user and/or at least one other payment method provided by the user, the difference in the real-time cost as determined by the ARI and the estimated cost provided by the integrated vacation packaging configurator platform.

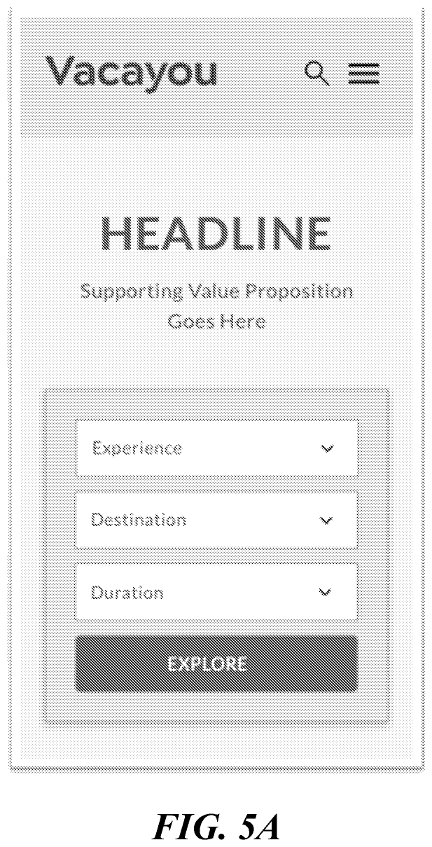

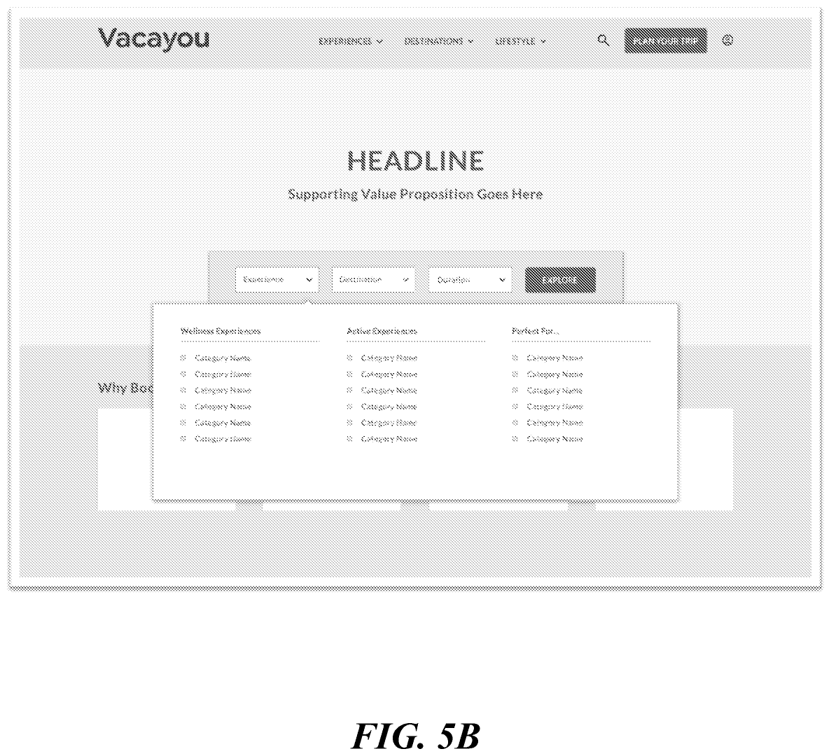

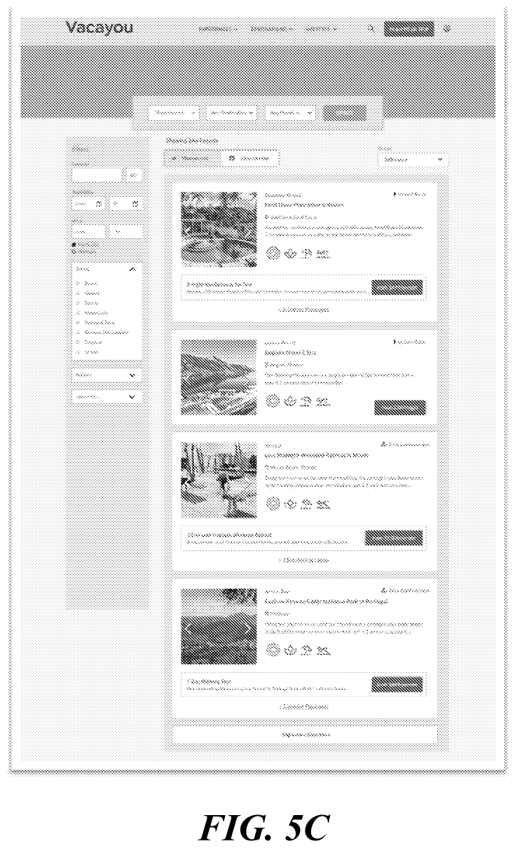

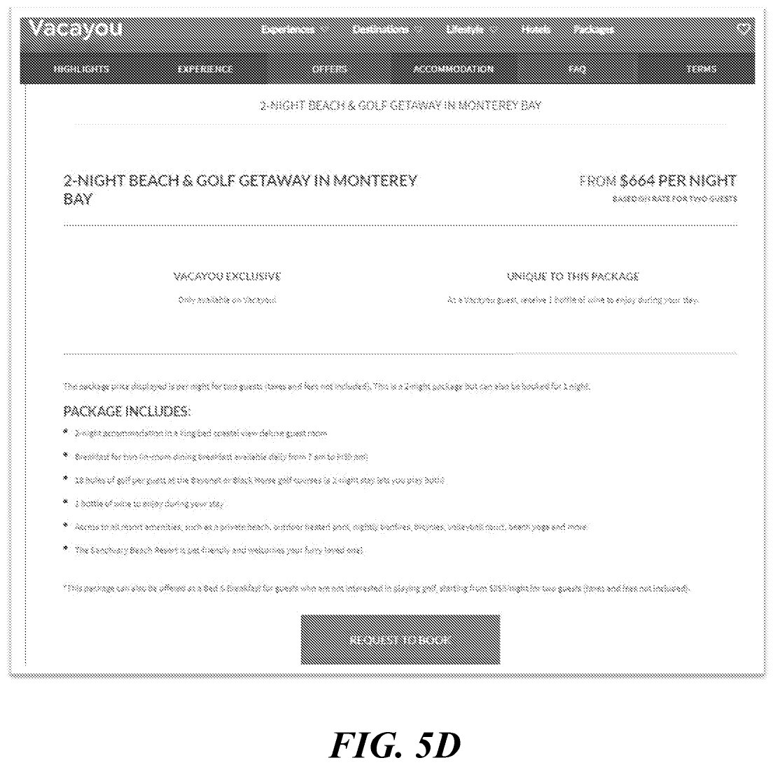

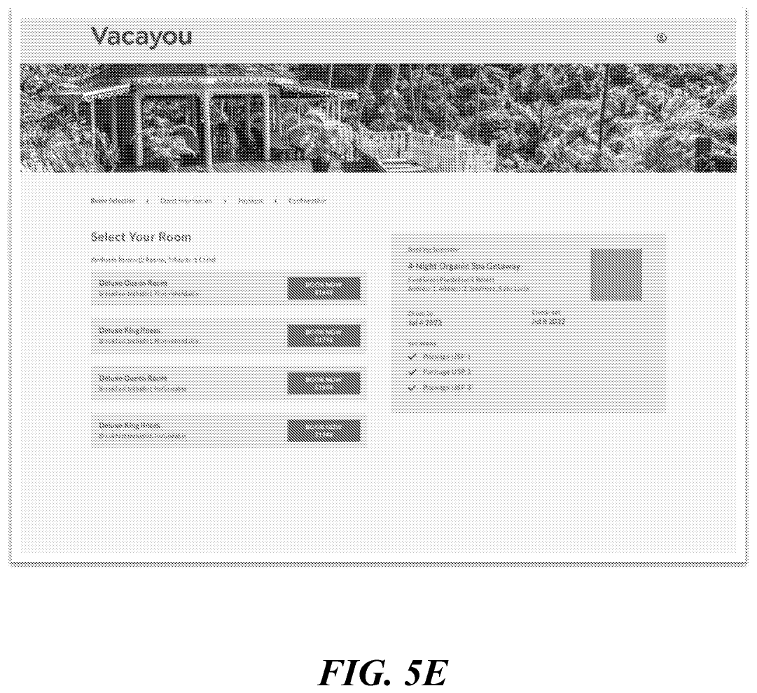

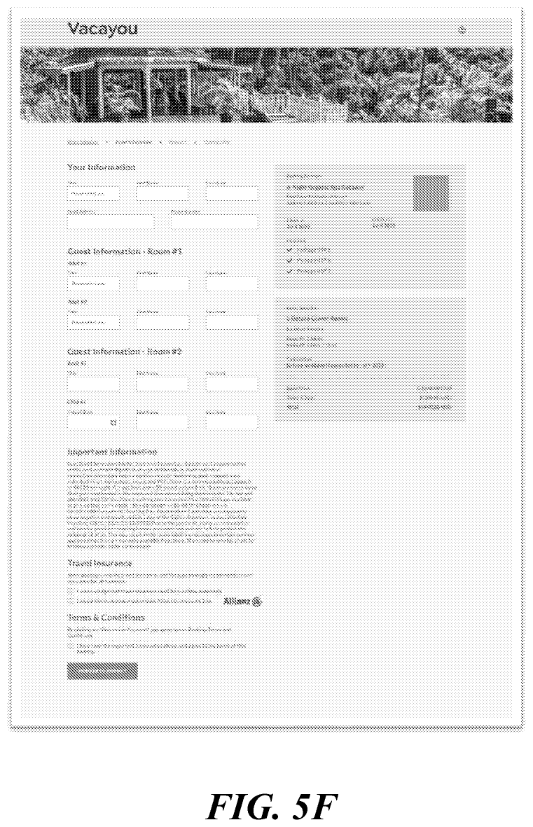

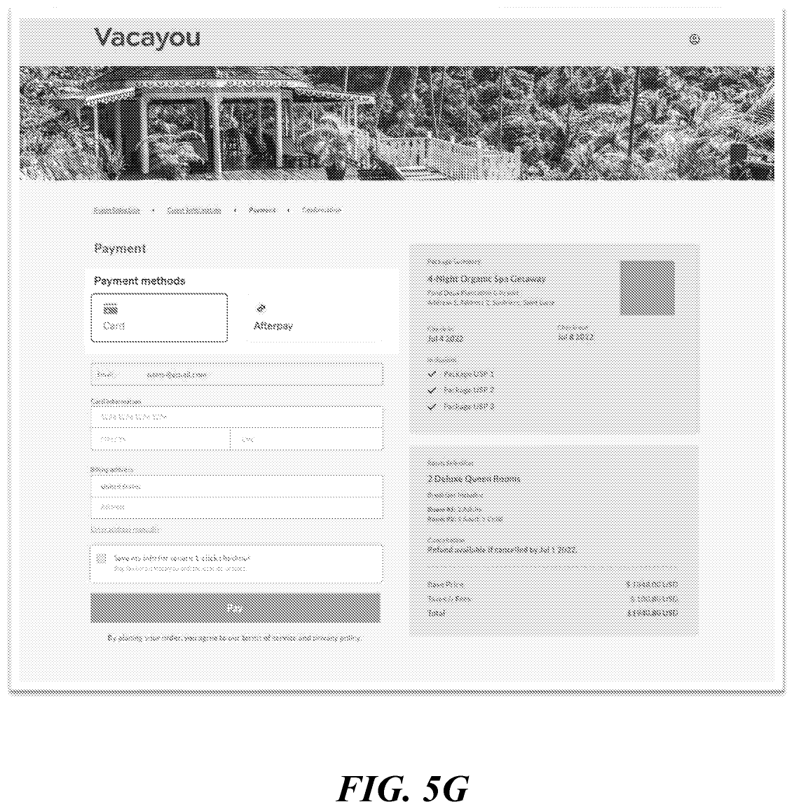

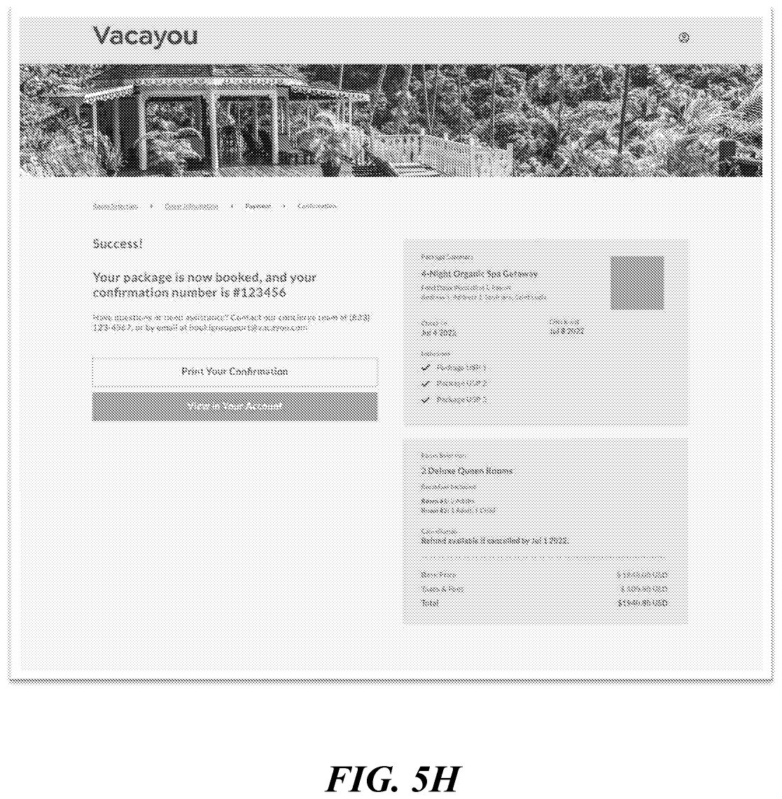

Moreover, another aspect of the present disclosure may further include the selection and booking of predetermined vacation packages as shown in FIGS. 5A-5H. FIG. 5A depicts an exemplary configuration of a vacation package preference profile of a vacation packaging configurator, according to an embodiment of the present disclosure. The preference profile aspect may include a plurality of options which the user may select, allowing the integrated vacation packaging configurator software to filter the potential predetermined vacation package matches. In an embodiment, the plurality of options includes, but is not limited to, country, state or province, perfect for, package type, setting, and/or duration. Additionally, the plurality of options of the preference profile aspect may increase or decrease based on the initial user selection. For example, in some embodiments, when the user selects a country outside of the United States, the user no longer has the option to select one of the fifty (50) states within the United States. In these other embodiments, the vacation packaging configurator automatically removes these options to allow the user to select valid and relevant selections, increasing the efficiency of the user on the vacation packaging configurator. Additionally, in some embodiments, the preference profile, the predetermined vacation packages may be filtered into several options, including but not limited to, active tour, getaway, immersive wellness, and/or retreat.

Moreover, as shown in FIG. 5B, in some embodiments, when the user selects a module within one of the plurality of options, the vacation packaging configurator may remove at least one alternative module within the same option. In this manner, when the user deselects the highlighted module, the at least one alternative module may be replaced. In some embodiments, the various modules within the plurality of options may be pre-selected by the vacation packaging configurator for convenience and may be altered by the user via the graphical user interface of a computing device. Furthermore, in some embodiments, as shown in FIG. 5B, some of the plurality of options may be removed entirely or grouped together to increase efficiency of the use on the vacation packaging configurator. For example, when the modules, such as “Beach” and “California” are selected, at least one alternative module within the “State or Province” option and “Setting” option may be removed from the preference profile aspect. In this manner, when the “California” module was selected, all alternative modules under the “Country” option may be removed from the selection.

FIGS. 5C-5D depict the predetermined vacation package of the vacation packaging configurator based on the selections of the user within the preference profile aspect, according to an embodiment of the present disclosure. In an embodiment, the hotel outputs may be presented in a top-down format. Accordingly, the vacation packaging configurator may present the predetermined vacation packages with the predetermined vacation package having closest matches to the user as the first vacation package presented at the top of the screen. Additionally, the vacation packaging configurator configures the predetermined vacation package, as shown in FIG. 5C, in a condensed form with only key aspects of the hotel provided, allowing the user to compare multiple vacation packages. As such, the user may interact with each predetermined vacation package provided by the vacation packaging configurator, provided additional details for each option, as shown in FIG. 5D. In some embodiments, the predetermined vacation packages may be presented in a left-to-right format.

In an embodiment, as shown in FIG. 5C, the vacation packaging configurator may automatically filter and provide the predetermined vacation platform with an activity rating, via an intensity algorithm. In this manner, the intensity algorithm of the vacation packaging configurator may be configured to input each of the plurality of activities within the predetermine vacation package, such that a rating may be provided relating to how active and/or strenuous the vacation package is considered. As such, the user may be allowed to see the activity rating on a module of the vacation packaging configurator, via the display device and/or the at least one user interface (e.g., a graphical user interface) to determine the level of activity and/or strain will be required within the predetermined vacation package. The rating categories may include, but are not limited to, relaxing, moderate, brisk, and/or intense. For example, four (4) day and/or night Organic Spa Getaway in Saint Lucia may be given a relaxing rating, while a seven (7) day and/or night Himalaya Everest Base Camp Trek may be given an intense rating by the vacation packaging configurator. Additionally, in some embodiments, the vacation packaging configurator may provide recommendations for predetermined vacation packages based on the preference profile of the user. Accordingly, a recommendation rating may be provided for each vacation package, with the predetermined vacation package most similar to the profile preference of the user receiving the highest rating and the vacation package least similar to the profile preference of the user receiving the lowest rating.

Another feature of the present disclosure is that the vacation packaging configurator, as shown in FIG. 5D, provides a detailed breakdown of the predetermined vacation package. The detailed breakdown may include but is not limited to, the duration of the stay, the features of the hotel, spa, and/or golf course, any potential food, unique aspects only provided by the vacation packaging configurator, and/or if the package is exclusive to the vacation packaging configurator. In some embodiments, the detailed breakdown may also incorporate highlights of the predetermined vacation package, reviews of the vacation package by previous users, photos and/or videos of the experience by previous users, a frequently asked questions section, and/or refund and/or cancellation terms for the predetermined vacation package.

FIG. 5E depicts a room selection of a selected vacation package of a vacation packaging configurator, according to an embodiment of the present disclosure. In an embodiment, after the user selects a property (e.g., hotel) package from the property outputs provided by the vacation packaging configurator, the vacation packaging configurator may be configured to display a module comprising the room selection, such that a user may interaction with the room selection module, via the graphical user interface of the computing device. Accordingly, the room selection module, as shown in FIG. 5E, may provide the user with at least one room option based on the preference profile aspect, as provided by the user. For example, for a user who inputs a preference profile aspect comprising 2 rooms, 3 adults, and one child, the room selection may provide several options which may conform to the preference profile (e.g., a deluxe queen room, a deluxe king room, standard queen room, a standard king room). Furthermore, in some embodiments, the room selection module may display at least experience, activity, and/or add-ons (e.g., rental vehicle, airfare, airline, kayaking, hiking, all-inclusive meals, complimentary Wi-Fi). Accordingly, in these other embodiments, the user may interact with the room selection module, via the graphical user interface of the computing device, such that the user may select the room based on the size, experiences, activities, and/or add-ons provided for the particular room based on the property package. Additionally, as shown in FIGS. 5E-5G, the vacation packaging configurator may display a vacation package summary, including but not limited to the selected vacation package location, the check-in and/or check-out time of the selected vacation package, the additional inclusions of the selected vacation package, the estimated cost of the selected vacation package, as provided by the vacation packaging configurator, refund information, and/or any information known in the art which would be included in booking a vacation package.

In an embodiment, once the user has selected the predetermined vacation package, the integrated vacation packaging configurator software may configure the at least one user interface (e.g., a graphical user interface) to display traveler information capture, a payment capture and/or a booking module, as shown in FIGS. 5F-5H. Additionally, the vacation packaging configurator may be configured to automatically book cancellation policies associated with the individual aspects of the predetermined vacation package without explicit user interaction. As shown in FIG. 5F, the traveler capture may comprise a module where the user may input their personal information and/or the personal information of at least one guest, via the graphical user interface of the computing device. In some embodiments, the traveler capture module may include a section where the user can provide a desired check-in date and a desired check-out date. Additionally, as shown in FIG. 5G, in an embodiment, information for at least one method of payment (e.g., credit cards, debit cards, Apple Pay, Venmo, Cryptocurrency) may be inputted by the user and cached by the vacation packaging configurator to complete all transactions, thereby reducing complexity of the booking process for the user, via the graphical user interface of the computing device. As such, the payment capture module may be configured to allow the user to input additional payment information from at least one additional third-party software in order to allow the user to pay through a predetermined payment software (e.g., monthly payments), via the graphical user interface of the computing device. For example, the user may input their profile data from a third-party payment software (e.g., Afterpay), such that the vacation packaging configurator may communicate with the third-party payment software, allowing the third-party payment software to provide the payment of the user at a predetermined time.

As shown in FIG. 5H, once the payment capture has been completed, the vacation packaging configurator may be configured to display a booking module, via the graphical user interface of the computing device. In this embodiment, the booking module may display a notification indicative of a successful and/or a non-successful booking. In this manner, the vacation packaging configurator may be configured to utilize API and/or ARI to confirm that all aspects of the selected vacation package and/or selected property package are available and have been booked by the vacation packaging configurator. Accordingly, if at least one aspect of the vacation package and/or at least one option of the property package are no longer available, the vacation packaging configurator may be configured to display a notification in the booking module indicative of a non-successful booking, via the graphical user interface of the computing device.

Furthermore, in some embodiments, once the user has successfully inputted the vacation packaging configurator may be configured to utilize the ARI to query the real-time cost of at least one aspect of the selected vacation package and/or the selected property package. As such, if at least one aspect of the selected vacation package and/or the selected property package has decreased, the booking module may be configured to automatically display a notification indicative of the vacation packaging configurator comprising a higher cost than necessary. Accordingly, in these other embodiments, the vacation packaging configurator may be configured to refund, via the inputted payment information provided by the user and/or at least one other payment method provided by the user, the difference in the real-time cost determined by the ARI and/or the estimate cost provided by the integrated vacation packaging configurator in a predetermined amount of time, providing the user with the lowest-cost available for the selected vacation package and/or the property package. Moreover, in some embodiments, the vacation packaging configurator may be configured to automatically refund the user, via the inputted payment information provided by user and/or at least one other payment method provided by the user, the difference in the real-time cost as determined by the ARI and the estimated cost provided by the integrated vacation packaging configurator platform.

In an embodiment, the booking module may include but is not limited to hotels, golf courses, spa retreats, hiking trips, flights, car rentals, restaurants, tours, and/or attractions. The vacation packaging configurator may be configured to use API to send the booking details to the aspects of the selected vacation package and/or property package to make the booking requests. In some embodiments, the vacation packaging configurator may be configured to allow the user to visit the third-parties associated with the selected vacation package and/or the selected property package to verify availability and price. In some embodiments, the vacation packaging configurator may automatically verify the availability and/or price of the aspects within the selected vacation package and/or the selected property package. Additionally, in some embodiments, the user may be able to view their reservation in one location on the vacation packaging configurator. In some embodiments, if the booking may be modified and/or cancelled, the vacation packaging configurator may be configured to allow the user to cancel and/or modify the booking, accordingly.

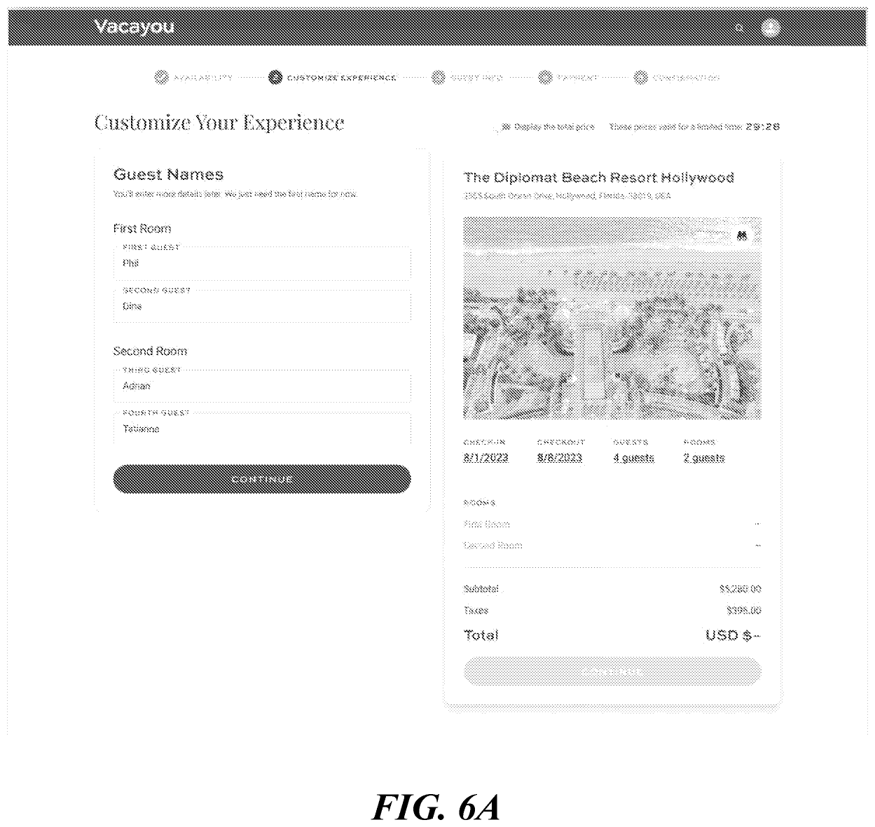

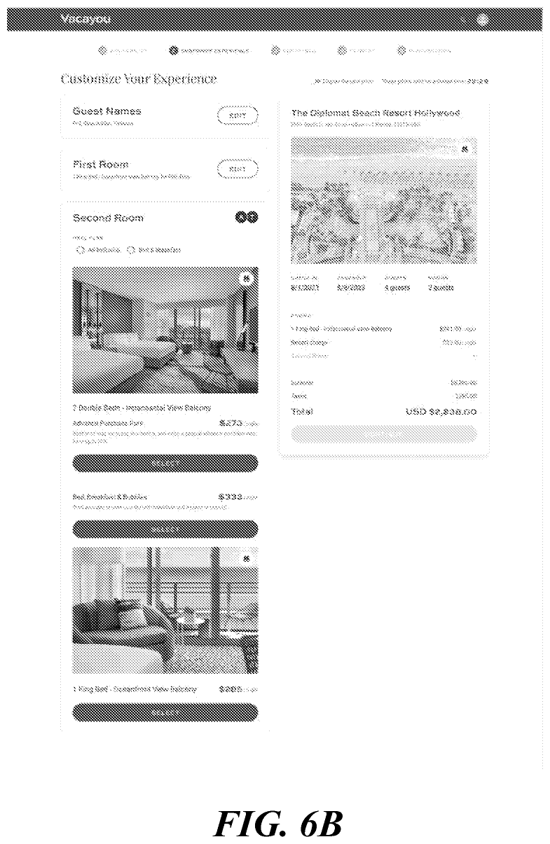

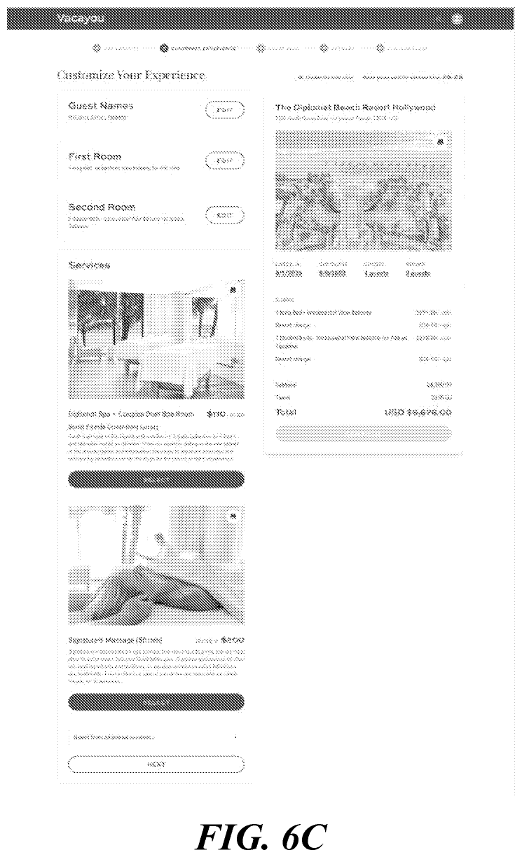

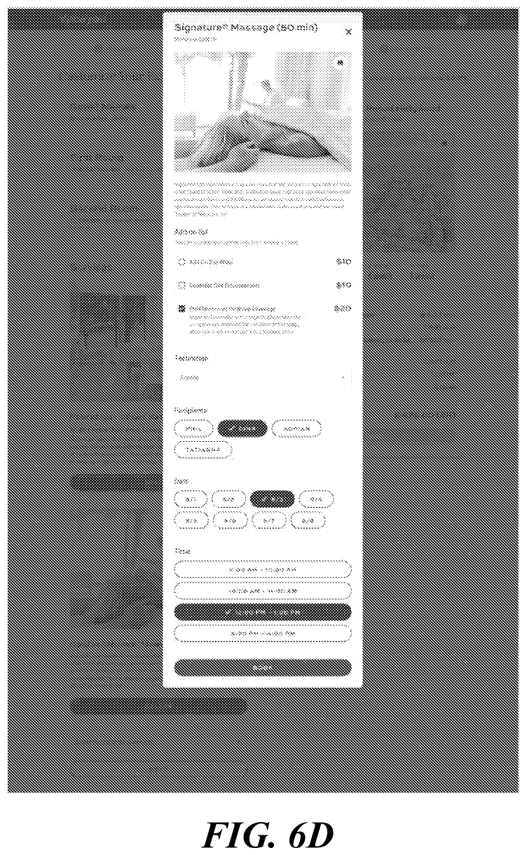

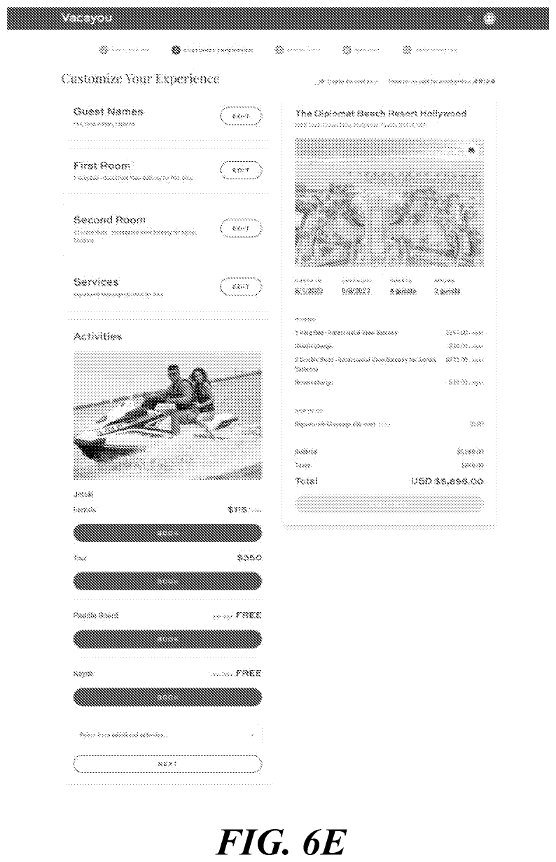

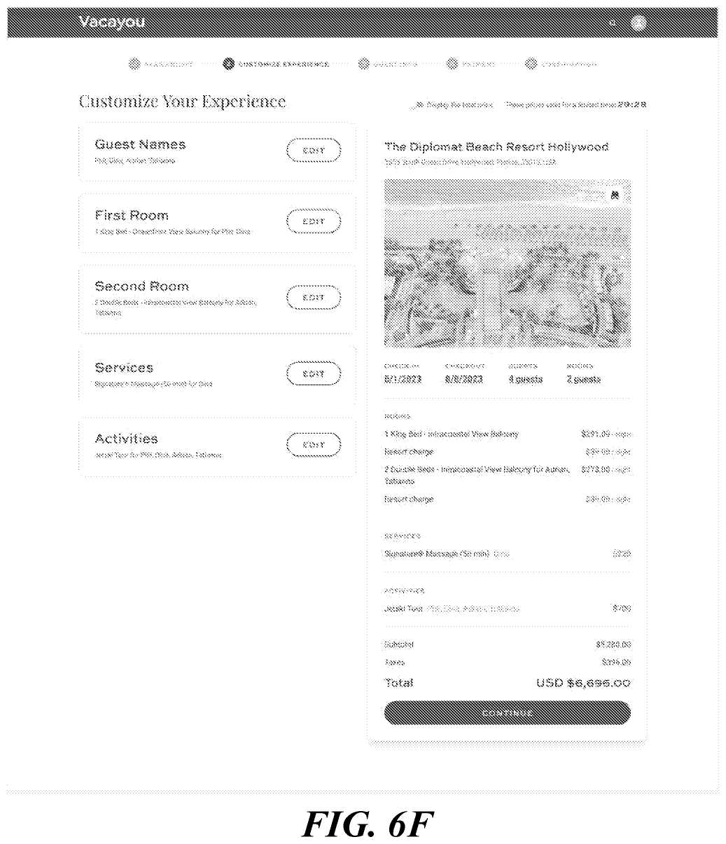

Furthermore, another aspect of the present disclosure pertains to customizing either the vacation package or the property package within the vacation packaging configurator, as shown in FIGS. 6A-6F. In this manner, as shown in FIGS. 6A-6F, in conjunction with FIGS. 3-5H, in an embodiment, once the user has selected the at least one wellness experience and/or the at least one property, within either the vacation package or the property package, the vacation packaging configurator may be provided to present a customizable module, such that the user may select at least one alternative aspect within the at least one wellness experience and/or the at least one property. As such, as shown in FIG. 6A, within the customizable module, the vacation packaging configurator may present the user with a guest button. Accordingly, within the guest button, the user may then assign and/or identify each option of the at least one wellness experience, and/or at least one room of the property to the user, at least one guest, and/or at least one alternative guest. For example, in some embodiments, when the user selects two rooms within the at least one property package, the customizable module of the vacation packaging configurator may be presented to the user, such that they may assign the first room to the user and/or at least one guest and/or the second room to the at least one guest.

Additionally, as shown in FIG. 6B, in an embodiment, the customizable module may be configured to allow the user, via the at least one user interface communicatively coupled to the computing device in association with the vacation packaging configurator to edit and/or amend the at least one option of the at least one wellness experience and/or at least one property, within the guest button. In this manner, the vacation packaging configurator may provide at the recommended option based on preference profile 104 of the user, as stated above, in addition to at least one alternative option which the user and/or the at least one guest may select based on their individual preference. In this embodiment, the customizable module may be configured to provide the real time price (e.g., $500/night and/or $5000/predetermined duration of time) of the recommended option and/or the at least one alternative option of the at least one wellness experience and/or the at least one property. For example, as shown in FIG. 6B, in this embodiment, when the user and/or the at least one guest is selecting a room within the at least one property, the customizable module may be configured to present on a module the recommended room and/or at least one alternative room within the at least one property. In this manner, the at least one alternative room may be ranked from most similar to preference profile 104 to least similar in a top-down formation. Furthermore, in this example, once the user has selected their room, the at least one guest may then select their room within a separate selection button, such that the user selection button is minimized optimizing space on the customizable module, such that the at least one guest may easily visualize each property option available. As such, in some embodiments, the customizable module may be configured to allow the user to select both the at least one option of the at least one wellness experience and/or the at least one property for both the user and the at least one guest.

In addition, in an embodiment, as shown in FIGS. 6C-6D, the customizable module may be configured to provide at least one additional and/or at least one alternative option to the user, such that user may add and/or replace at least one option within the vacation package and/or the property package with at least one additional wellness experience and/or at least one alternative wellness experience for the user and/or the at least one guest. In this embodiment, as shown in FIGS. 6C-6D, the customizable module may be configured to provide at a service button, such that the service button is highlighted when selected, providing additional aspects of the at least one wellness experience, including but not limited to additional add-on aspects of the wellness experience to include and/or at least one alternative aspect of the wellness experience to change from the original vacation package and/or property package. In this manner, the service button may also comprise a section, such that the user and/or the at least one guest may select a specified technician and/or expert related to the at least one wellness experience and/or any technician and/or expert available.

In addition, as shown in FIGS. 6C-6D, in this embodiment, the customizable module may comprise at least one additional section, such that the user may select which individual (e.g., the user and/or the at least one guest) is going to participate in the at least one add-on aspect and/or alternative aspect of the at least one selected wellness experience. Moreover, as shown in FIGS. 6C-6D, in conjunction with FIG. 3, in this embodiment, the service button may further comprise at least one section to determine which date and/or time within the predetermined date range, as determined by availability and preference profile 104 of the user, the at least one additional add-on aspect and/or the at least one alternative aspect of the at least one wellness experience may take place within the vacation package and/or the property package. Furthermore, the service button may comprise a booking button, such that vacation packaging configurator may automatically update the real-time price of the overall selected vacation package and/or property package based on the additional and/or new price provided by the at least one add-on aspect and/or the at least one alternative aspect, respectively, of the at least one wellness experience.

FIG. 6E depicts the customizable module comprising an activities button in communication with at least one third-party software, program, and/or computing device, via any booking API known in the art, according to an embodiment of the present disclosure. In this embodiment, the customizable module may provide the user with the activities button, such that the user may select at least one additional wellness experience available from the at least one selected property and/or at least one third-party wellness experience provider within a predetermined distance from the selected property of the vacation package and/or the property package. In some embodiments, the at least one third-party wellness experience provider may be associated with the at least one wellness experience and/or the at least one property, such that the vacation packaging configurator may provide deals and/or reduced pricing on the at least one wellness activity within the activities button. In this manner, if the third-party wellness experience provider is not associated with the at least one selected property, the full-real time price of the wellness experience within the activities button may be provided, via API. For example, as shown in FIG. 6E, in some embodiments, the activities button may comprise jet ski rentals and/or tours, paddle boards, and/or kayaks. In this example, the activities module may provide real-time pricing of the at least one wellness experience, and/or may show that the real-time pricing has been reduced, via verbal and/or visual communication (e.g., a line through the original pricing with the discounted pricing available in red adjacent to the original pricing). Furthermore, in some embodiments, at least one wellness activity within the activities button may be no additional charge if they are originally provided by the at least one selected property and/or if the at least one selected property has provided a discount based on the relationship between the at least one selected property and/or the third-party wellness provider, vice versa, and/or based on the type of vacation package and/or property package selected by the user.

Furthermore, as shown in FIG. 6F, in an embodiment, when the user has selected all options within the customizable module, the vacation packaging configurator may be configured to automatically provide an updated real-time price based on the options selected by the user within the customizable module. As such, the customizable module may provide an updated total cost and/or travel itinerary based on the at least one selected option within the customizable module, such that the vacation packaging configurator may provide the updated total cost and/or travel itinerary to the user via the display device and/or the at least one user interface (e.g., graphical user interface) communicatively coupled to the computing device in association with the vacation packaging configurator. In this manner, once the user has received the updated real-time total cost and/or travel itinerary, the vacation packaging configurator may be configured to provide a highlighted button within the customizable module, such that once selected the user may continue to the user information module, as shown in FIG. 5F.

### Method of Use

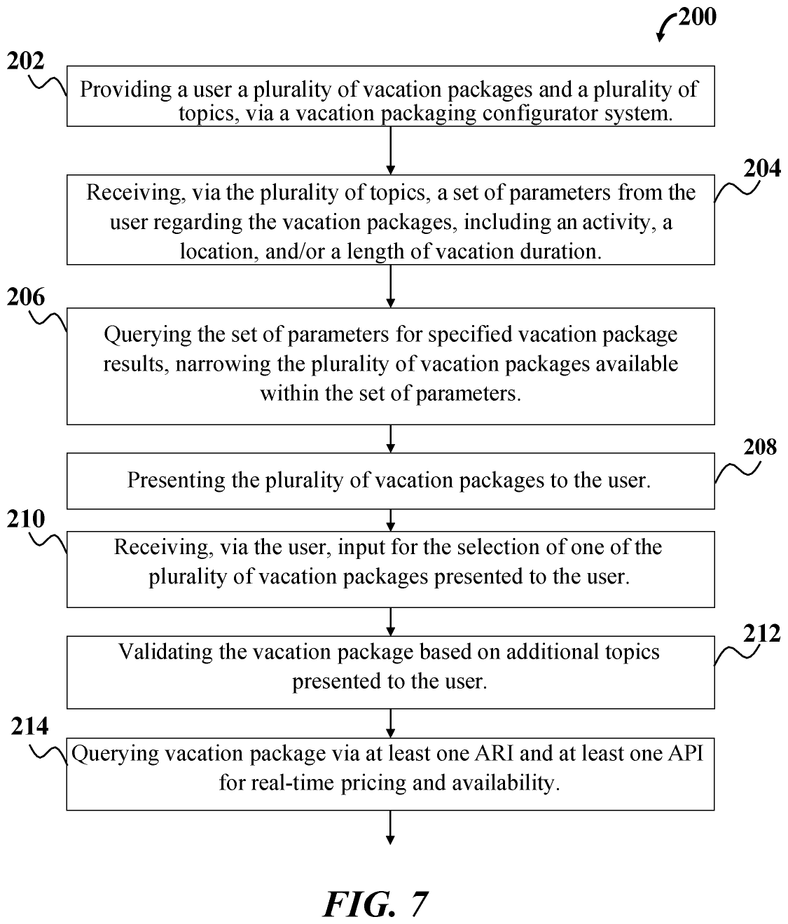

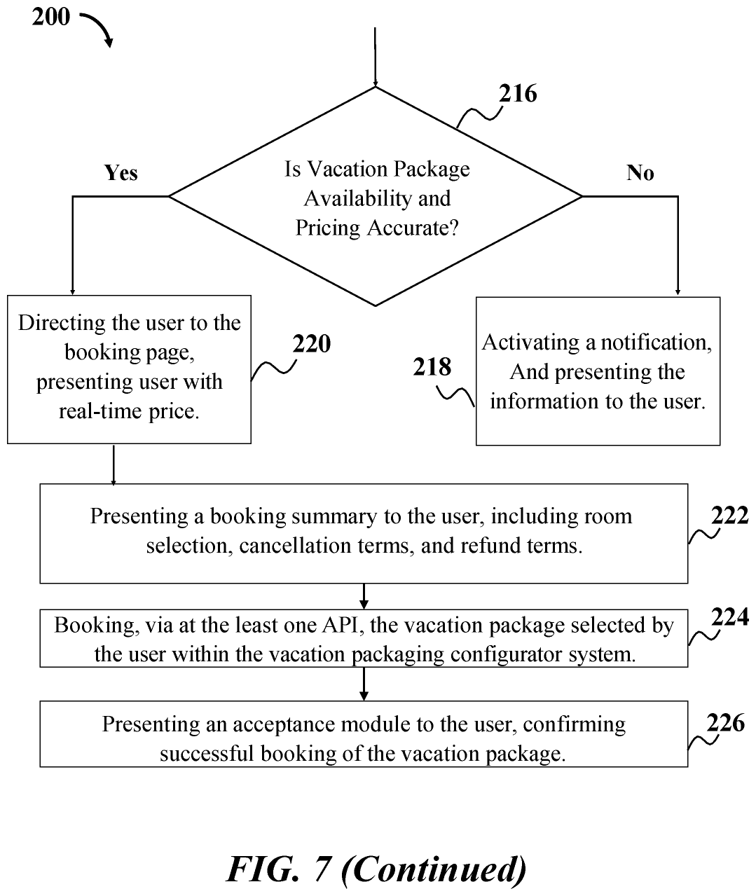

FIG. 7 depicts an exemplary process flow diagram depicting a method for digitally booking a vacation package on a computing device and/or providing real-time availability and/or prices in order to aid a user's vacation booking performance. The steps delineated in FIG. 7 are merely exemplary of an order of digitally booking a vacation package on a computing device. The steps may be carried out in another order, with or without additional steps included therein.

As shown in FIG. 7, in conjunction with FIGS. 1-6F, the method 200 begins at step 202, in which the vacation packaging configurator provides the user with a plurality of vacation packages and a plurality of travel topics. In an embodiment, this step may comprise communicatively coupling with ARI and/or API within the software to search and/or cache data of the plurality of travel topics within the vacation package.

Next, at step 204, the vacation packaging configurator receives, via the plurality of travel topics, the set of parameters from the user regarding the vacation packages. In an embodiment, the set of parameters from the user may include, but is not limited to, activity, location, and/or length of vacation duration. Further, at step 206 of method 200, as shown in FIG. 7, the vacation packaging configurator may be configured to query the set of parameters for certain vacation package results that are closely related to the plurality of travel topics selected by the user. In an embodiment, at step 208, the plurality of vacation packages may be presented to the user via the interface of the computing device. In an embodiment, the plurality of vacation packages presented to the user may be automatically narrowed based on the set of parameters provided by the user.

Following presenting the plurality of vacation packages to the user, at step 210 of method 200, as shown in FIG. 7, the vacation packaging configurator may receive input for the selection of one of the plurality of vacation packages presented to the user. In this embodiment, when the user selects one of the plurality of the vacation packages, the user may be sent to the booking module. Before the user is sent to the booking module, at step 212, respectively, the vacation packaging configurator may be configured to present at least one additional parameters to the user to verify the availability of the vacation package to the user. In an embodiment the additional parameters may include, but not limited to, age, allergies, and/or number of users within the group selecting the vacation package.

Next, at step 214, the vacation packaging configurator may then query the vacation package via the use of the at least one ARI and/or the at least one API to collect and/or cache the most recent vacation data topic to determine the real-time pricing and/or availability of the vacation package.

Moreover, at step 216, in this embodiment, the vacation packaging configurator may compare the received real-time price and/or availability cached from the at least one ARI and/or the at least one API to the cost and/or availability originally cached from the initial search using the at least one ARI and/or the at least one API. The method then proceeds to either step 218 or step 220 depending on whether a substantial match exists between the real-time price and/or availability and/or the original price and/or availability. In some embodiments, the vacation packaging configurator may regularly update the original price at predetermined intervals to maintain accuracy of availability and rates.

Referring again to FIG. 7, during step 218, the vacation packaging configurator determines that a substantial match does not exist between the real-time price and availability of the vacation package and the original price and availability. As such, during step 218, in an embodiment, the vacation packaging configurator may execute instructions to transmit a notification indicative of the real-time price and/or available of the vacation package not matching the original price and/or availability provided by the vacation packaging configurator and/or presenting the information to the user. In some embodiments, the vacation packaging configurator in association with the computing device may verbalize and/or visualize the notification of the vacation packaging configurator on the display device and/or at least one user interface (e.g., graphical user interface) communicatively coupled to the computing device..

During step 220, the integrated vacation packaging configurator system determines that a substantial match does exist between the real-time price and availability of the vacation package and the original availability and price. Accordingly, during step 220, in this embodiment, the vacation packaging configurator may direct the user to the booking module, such that the user may be presented with the real-time price and/or availability of the vacation package.

Next, at step 222, the vacation packaging configurator may be configured to present the user a booking summary on the booking module, including but not limited to room selection, cancellation terms, and/or refund terms. In an embodiment, the vacation packaging configurator may automatically enter the personal and/or the payment information of the user to optimize the booking process for the user. Next, at step 224, the vacation packaging configurator automatically books the aspects of the vacation package, via at least one API, using the personal and/or the payment information of the user, increasing the efficiency of the vacation booking of the user.

Finally, the method then proceeds to step 226. At step 226, as shown in FIG. 7, in this embodiment, the vacation packaging configurator may provide the user with an acceptance module, confirming successful booking of the vacation package. In some embodiments, if an issue arises within the booking process, the vacation packaging configurator may provide the user a notification of the error, and subsequently, with several solutions to alleviate the booking issue. Additionally, in some embodiments, the notification of the error may be verbalized and/or be visualized by the vacation packaging configurator, via the display device and/or at least one user interface communicatively coupled to the computing device in association with the vacation packaging configurator. In some embodiments, the vacation packaging configurator may be configured to display and/or present the real-time pricing and/or availability of the vacation package within the booking module to the user with a predetermined time-limit (e.g., 10 minutes), such that the user must complete the booking process and/or be presented with the acceptance module of the vacation packaging configurator within the predetermined time-limit. As such, in these other embodiments, if the user fails to complete the booking process and/or be presented with the acceptance module within the predetermined time-limit, method 200 may reset, such that the user must restart the process, starting at step 202.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Liu, Yinyin, et al. Integrated Travel Platform for Personalized Trip Exploration, Planning, and Booking. US 2021/0326780 A1, United States Patent and Trademark Office, 21 Oct. 2021.

All publications, patents, and/or patent applications mentioned in this specification are herein incorporated by reference to the same extent as if each individual publication, patent, and/or patent application was specifically and individually indicated to be incorporated by reference. To the extent the publications, patents and/or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method for optimizing vacation package structuring, booking, and viewing, the method comprising:
providing, via a vacation package configurator, a plurality of travel topics to a user;
generating, via incorporating at least one user selected travel topic of the plurality of travel topics within the vacation package configurator, a set of parameters associated with a vacation;
analyzing, via a compatibility algorithm of the vacation package configurator, the set of parameters to identify, create, or both at least one recommended vacation package, property package, or both, wherein the at least one recommended vacation package, property package, or both has a highest value of dynamism with respect to the set of parameters;
receiving, via at least one user interface associated with the vacation package configurator, a selection corresponding to the least one recommended vacation package, the property package, or both;
validating, using at least one third-party application programming interface (hereinafter “API”), at least one Availability, Rates, and Inventory programming interface (hereinafter “ARI”), or both, a pricing, an availability, or both of the at least one selected vacation package, selected property package, or both, in real-time; and
automatically booking, based on the real-time validation of the pricing, availability or both, the selected vacation package, the selected property package, or both.

2. The method of claim 1, wherein the step of validating the at least one selected vacation package, property package, or both further comprises the step of, comparing an original pricing, original availability, or both of the at least one selected vacation package, property package, or both with the real-time pricing, real-time availability, or both of the at least one selected vacation package, property package, or both provided by the at least one API, at least one ARI, or both.

3. The method of claim 2, wherein the step of automatically booking the at least one selected vacation package, property package, or both, further comprises the steps of,
based on a determination that the original pricing, original availability, or both of the at least one selected vacation package, property package, or both does not match the real-time pricing, the real-time availability or both of the at least one selected vacation package, property package, or both, transmitting a notification indicative of an inability to book the at least one selected vacation package, property package, or both; and
based on a determination that the original pricing, original availability, or both of the at least one selected vacation package, property package, or both matches the real-time pricing, the real-time availability or both of the at least one selected vacation package, property package, or both, transmitting a notification indicative of successfully booking the at least one selected vacation package, property package, or both.

4. The method of claim 1, further comprising the step of, presenting to the user an acceptance module comprising a booking summary of the at least one selected vacation package, property package, or both.

5. The method of claim 4, wherein the booking summary comprises a room selection, cancellation terms, and refund terms.

6. The method of claim 1, wherein the step of presenting the at least one recommended vacation package, property package, or both comprises providing the at least one recommended vacation package, property package, or both in list formatting.

7. The method of claim 6, wherein the at least one recommended vacation package, property package, or both with the highest value of dynamism appears at the top of the list.

8. The method of claim 1, wherein the vacation packaging configurator further comprises a customizable module.

9. The method of claim 8, further comprising the step of, updating, via the customizable module, at least one wellness experience, at least one property option, or both of the at least one selected vacation package, property package, or both.

10. The method of claim 9, wherein the step of updating the at least one wellness experience, the at least one property option, or both of the at least one selected vacation package, property package, or both further comprises the step of, assigning, via the customizable module, the at least one wellness experience, the at least one property option, or both to the user, at least one guest, or both.

11. The method of claim 9, wherein the step of updating the at least one wellness experience, the at least one property option, or both of the at least one selected vacation package, property package, or both further comprises the step of, automatically updating, via the at least one API, at least one ARI, or both, the real-time price of the at least one selected vacation package, property package, or both.

12. A vacation packaging configurator system for structuring, booking, and viewing vacation packages, the system comprising:
a preference profile module configured to receive a set of parameters associated with a vacation;
a recommendation module configured to analyze the set of parameters to identify, create, or both at least one recommended vacation package, property package, or both, wherein the at least one recommended vacation package, property package, or both has a highest value of dynamism with respect to the set of parameters;
a real-time package availability and pricing module configured to validate, using at least one third-party application programming interface (hereinafter “API”), at least one Availability, Rates, and Inventory programming interface (hereinafter “ARI”), or both, a pricing, an availability, or both of the at least one recommended vacation package, property package, or both;
a booking module configured to automatically book the at least one recommended vacation package, property package, or both; and
an acceptance module configured to present to the user an acceptance module of the at least one recommended vacation package, property package, or both.

13. The vacation packaging configurator system of claim 12, wherein the real-time package availability and pricing module is further configured to compare an original pricing, original availability, or both of the at least one recommended vacation package, property package, or both with the real-time pricing, real-time availability, or both of the at least one recommended vacation package, property package, or both provided by the at least one API, at least one ARI, or both.

14. The vacation packaging configurator system of claim 12, wherein the acceptance module is further configured to present a booking summary to the user.

15. The vacation packaging configurator system of claim 14, wherein the booking summary comprises a room selection, cancellation terms, and refund terms.

16. The vacation packaging configurator system of claim 12, further comprising a customizable module configured to update at least one wellness experience, at least one property option, or both of the at least one recommended vacation package, property package, or both.

17. The vacation packaging configurator system of claim 16, wherein the customizable module is further configured to assign the at least one wellness experience, the at least one property option, or both to the user, at least one guest, or both.

18. The vacation packaging configurator system of claim 16, wherein the customizable module is further configured to automatically update, via the at least one API, at least one ARI, or both, the real-time price of the at least one recommended vacation package, property package, or both.

19. The vacation packaging configurator system of claim 12, further comprising an interface module configured to communicatively couple at least one selected from the group consisting of a third-party program, software, and computing device with the vacation packaging configurator system.

20. A method for optimizing vacation package structuring, booking, and viewing, the method comprising:
generating a set of parameters from a user, wherein at least one of the set of parameters comprises a location, a duration of a vacation, or both;
analyzing the set of parameters to identify, create, or both at least one vacation package, property package, or both, wherein the at least one vacation package, property package, or both has a highest value of dynamism with respect to the set of parameters;
validating, using at least one third-party application programming interface (hereinafter “API”), at least one Availability, Rates, and Inventory programming interface (hereinafter “ARI”), or both, a pricing, an availability, or both of the at least one vacation package, the at least one property package, or both, in real-time; and
automatically booking, the at least one vacation package, the at least one property package, or both by:
based on a determination that an original pricing, an original availability, or both of the at least one vacation package, property package, or both does not match the real-time pricing, the real-time availability, or both of the at least one vacation package, property package, or both, transmitting a notification indicative of an inability to book the at least one vacation package, property package, or both; and
based on a determination that an original pricing, an original availability, or both of the at least one vacation package, property package, or both matches the real-time pricing, the real-time availability, or both of the at least one vacation package, property package, or both, transmitting a notification indicative of successfully booking the at least one vacation package, property package, or both.
